(19) United States
(12) Patent Application Publication
(10) Pub. No.: US 2024/0257013 A1
(43) Pub. Date: Aug. 1, 2024

(54) IMPACT ENHANCING RECOMMENDATIONS FOR RESEARCH PAPERS AND INITIATIVES

(71) Applicant: Dell Products, L.P., Round Rock, TX (US)

(72) Inventors: Eloy Francisco Macha, Crowley, TX (US); Stephen James Todd, North Andover, MA (US); Robert Anthony Lincourt, JR., Franklin, MA (US); David Edward Frattura, Stamford, CT (US)

(21) Appl. No.: 18/162,265

(22) Filed: Jan. 31, 2023

(51) Int. Cl. G06Q 10/0637; G06F 3/0482; G06F 3/0484; G06F 40/174

(52) U.S. Cl. CPC G06Q 10/0637; G06F 3/0482; G06F 3/0484; G06F 40/174

(57) ABSTRACT

A method and system for impact enhancing recommendations for research papers and initiatives. People, amongst research circles, often write and publish research papers, and/or pursue research initiatives, without any foreknowledge regarding the impact potential (e.g., usefulness and/or success) of their respective research work. Said people, at times, may find that their efforts are wasted due to poor peer-review reception and/or to little to zero response from one or more industries. To ensure that future time and effort, which may be put into any unbegun research work, are not fruitless, embodiments disclosed herein leverage collected metadata on past, impactful research work in order to evaluate said any unbegun research work with respect to an impact factor thereof. Embodiments disclosed herein, further, provide guidance, pertaining to a number of research work related aspects, to enhance the impact factor of said any unbegun research work.

### BACKGROUND

Organization strategy may reference a plan (or a sum of actions), intended to be pursued by an organization, directed to leveraging organization resources towards achieving one or more long-term goals. Said long-term goal(s) may, for example, relate to identifying or predicting future or emergent trends across one or more industries. Digitally-assisted organization strategy, meanwhile, references the scheming and/or implementation of organization strategy, at least in part, through insights distilled by artificial intelligence.

### SUMMARY

In general, in one aspect, embodiments disclosed herein relate to a method for providing guidance. The method includes: detecting an initiation, by an organization user, of an impact assessment program; instantiating an interactive assessment form including a set of form fields; presenting, through the impact assessment program, the interactive assessment form to the organization user; monitoring interactions, by the organization user, with the interactive assessment form to identify an engagement action; analyzing, based on the engagement action and to obtain guidance information, an impactful corpus catalog including a set of catalog entries; and providing, through the interactive assessment form, the guidance information to the organization user.

In general, in one aspect, embodiments disclosed herein relate to a non-transitory computer readable medium (CRM). The non-transitory CRM includes computer readable program code, which when executed by a computer processor, enables the computer processor to perform a method for providing guidance. The method includes: detecting an initiation, by an organization user, of an impact assessment program; instantiating an interactive assessment form including a set of form fields; presenting, through the impact assessment program, the interactive assessment form to the organization user; monitoring interactions, by the organization user, with the interactive assessment form to identify an engagement action; analyzing, based on the engagement action and to obtain guidance information, an impactful corpus catalog including a set of catalog entries; and providing, through the interactive assessment form, the guidance information to the organization user.

In general, in one aspect, embodiments disclosed herein relate to a system. The system includes: a client device; and an insight service operatively connected to the client device, and including a computer processor configured to perform a method for providing guidance. The method includes: detecting an initiation, by an organization user operating the client device, of an impact assessment program executing on the client device; instantiating an interactive assessment form comprising a set of form fields; presenting, through the impact assessment program, the interactive assessment form to the organization user; monitoring interactions, by the organization user, with the interactive assessment form to identify an engagement action; analyzing, based on the engagement action and to obtain guidance information, an impactful corpus catalog including a set of catalog entries; and providing, through the interactive assessment form, the guidance information to the organization user.

Other aspects disclosed herein will be apparent from the following description and the appended claims.

### BRIEF DESCRIPTION OF DRAWINGS

FIG. 1A shows a system in accordance with one or more embodiments disclosed herein.

FIG. 1B shows a client device in accordance with one or more embodiments disclosed herein.

FIG. 2A shows an example connected graph in accordance with one or more embodiments disclosed herein.

FIGS. 2B-2D show example k-partite connected graphs in accordance with one or more embodiments disclosed herein.

FIGS. 3A-3F show flowcharts describing a method for impact enhancing recommendations for research papers and initiatives in accordance with one or more embodiments disclosed herein.

FIG. 4 shows an example computing system in accordance with one or more embodiments disclosed herein.

FIG. 5A-5C show an example scenario in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding disclosed herein. However, it will be apparent to one of ordinary skill in the art that the embodiments disclosed herein may be practiced without these specific details. In other instances, well-known features have not been described in detail to avoid unnecessarily complicating the description.

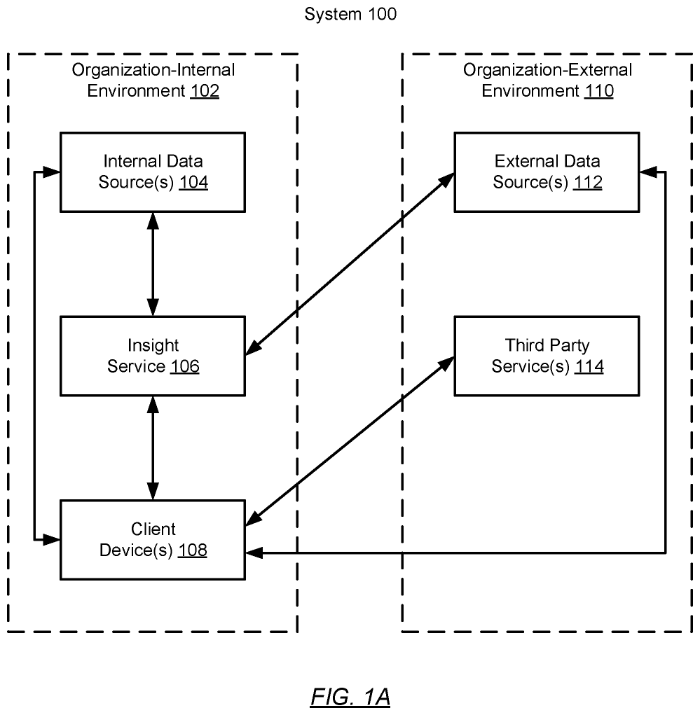

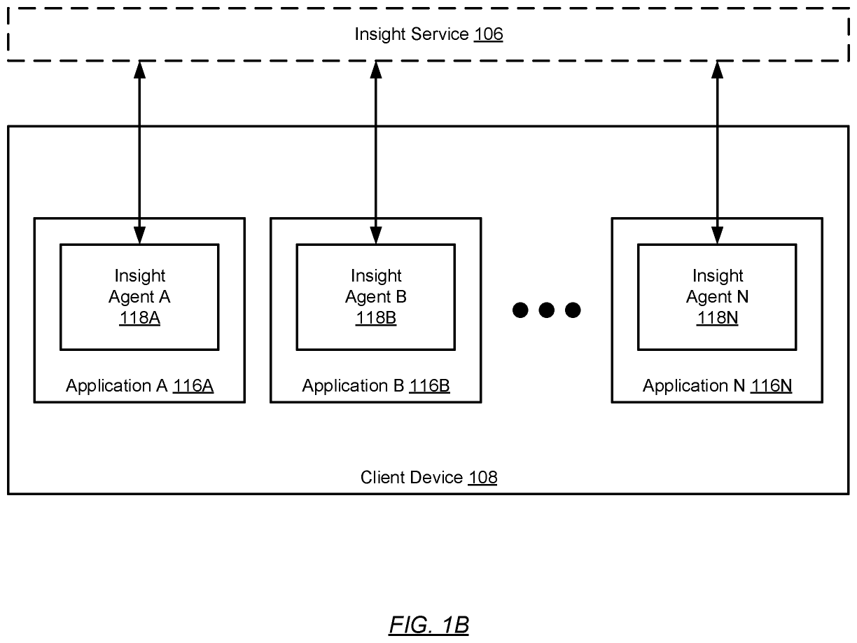

In the following description of FIGS. 1A-5C, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments disclosed herein relate to impact enhancing recommendations for research papers and initiatives. People, amongst research circles, often write and publish research papers, and/or pursue research initiatives, without any foreknowledge regarding the impact potential (e.g., usefulness and/or success) of their respective research work. Said people, at times, may find that their efforts are wasted due to poor peer-review reception and/or to little to zero response from one or more industries. To ensure that future time and effort, which may be put into any unbegun research work, are not fruitless, embodiments disclosed herein leverage collected metadata on past, impactful research work in order to evaluate said any unbegun research work with respect to an impact factor thereof. Embodiments disclosed herein, further, provide guidance, pertaining to a number of research work related aspects, to enhance the impact factor of said any unbegun research work.

FIG. 1A shows a system in accordance with one or more embodiments disclosed herein. The system (100) may include an organization-internal environment (102) and an organization-external environment (110). Each of these system (100) components is described below.

In one or many embodiment(s) disclosed herein, the organization-internal environment (102) may represent any digital (e.g., information technology (IT)) ecosystem belonging to, and thus managed by, an organization. Examples of said organization may include, but are not limited to, a business/commercial entity, a higher education school, a government agency, and a research institute. The organization-internal environment (102), accordingly, may at least reference one or more data centers of which the organization is the proprietor. Further, the organization-internal environment (102) may include one or more internal data sources (104), an insight service (106), and one or more client devices (108). Each of these organization-internal environment (102) subcomponents may or may not be co-located, and thus reside and/or operate, in the same physical or geographical space. Moreover, each of these organization-internal environment (102) subcomponents is described below.

In one or many embodiment(s) disclosed herein, an internal data source (104) may represent any data source belonging to, and thus managed by, the above-mentioned organization. A data source, in turn, may generally refer to a location where data or information (also referred to herein as one or more assets) resides. An asset, accordingly, may be exemplified through structured data/information (e.g., tabular data/information or a dataset) or through unstructured data/information (e.g., text, an image, audio, a video, an animation, multimedia, etc.). Furthermore, any internal data source (104), more specially, may refer to a location that stores at least a portion of the asset(s) generated, modified, or otherwise interacted with, solely by entities (e.g., the insight service (106) and/or the client device(s) (108)) within the organization-internal environment (102). Entities outside the organization-internal environment may not be permitted to access any internal data source (104) and, therefore, may not be permitted to access any asset(s) maintained therein.

Moreover, in one or many embodiment(s) disclosed herein, any internal data source (104) may be implemented as physical storage (and/or as logical/virtual storage spanning at least a portion of the physical storage). The physical storage may, at least in part, include persistent storage, where examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) disclosed herein, the insight service (106) may represent information technology infrastructure configured for digitally-assisted organization strategy. In brief, organization strategy may reference a plan (or a sum of actions), intended to be pursued by an organization, directed to leveraging organization resources towards achieving one or more long-term goals. Said long-term goal(s) may, for example, relate to identifying or predicting future or emergent trends across one or more industries. Digitally-assisted organization strategy, meanwhile, references the scheming and/or implementation of organization strategy, at least in part, through insights distilled by artificial intelligence. An insight, in turn, may be defined as a finding (or more broadly, as useful knowledge) gained through data analytics or, more precisely, through the discovery of patterns and/or relationships amongst an assortment of data/information (e.g., assets). The insight service (106), accordingly, may employ artificial intelligence to ingest assets maintained across various data sources (e.g., one or more internal data sources (104) and/or one or more external data sources (112)) and, subsequently, derive or infer insights therefrom that are supportive of an organization strategy for an organization.

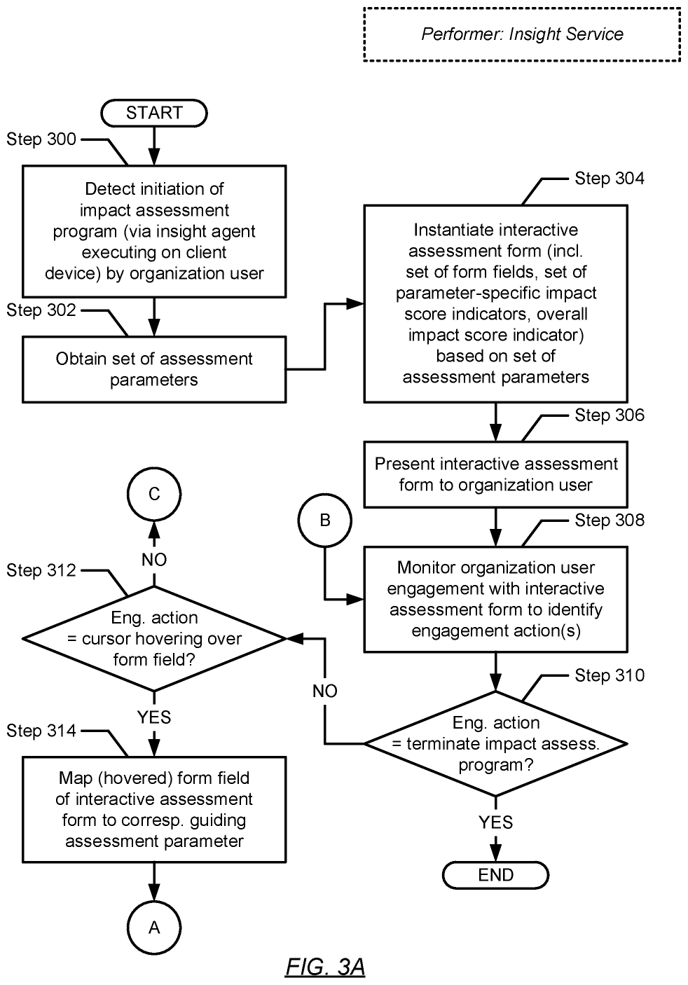

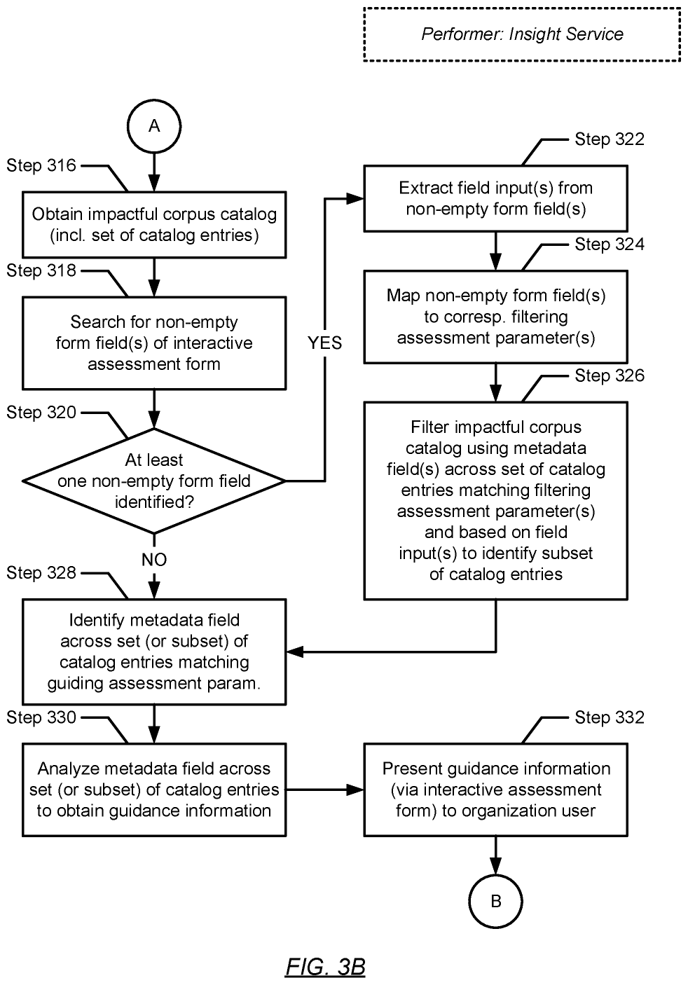

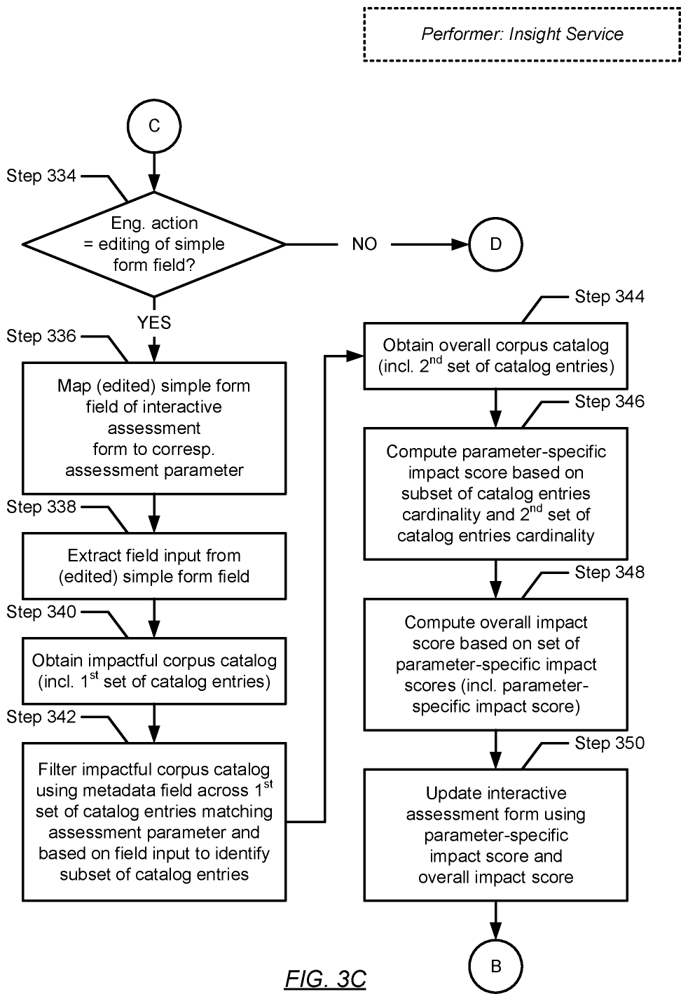

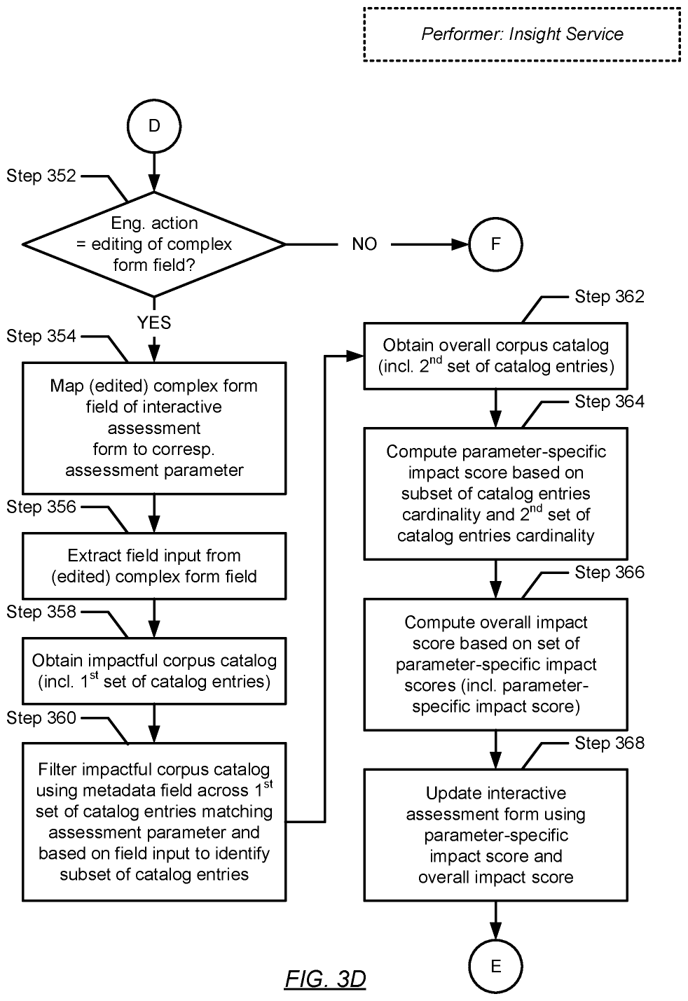

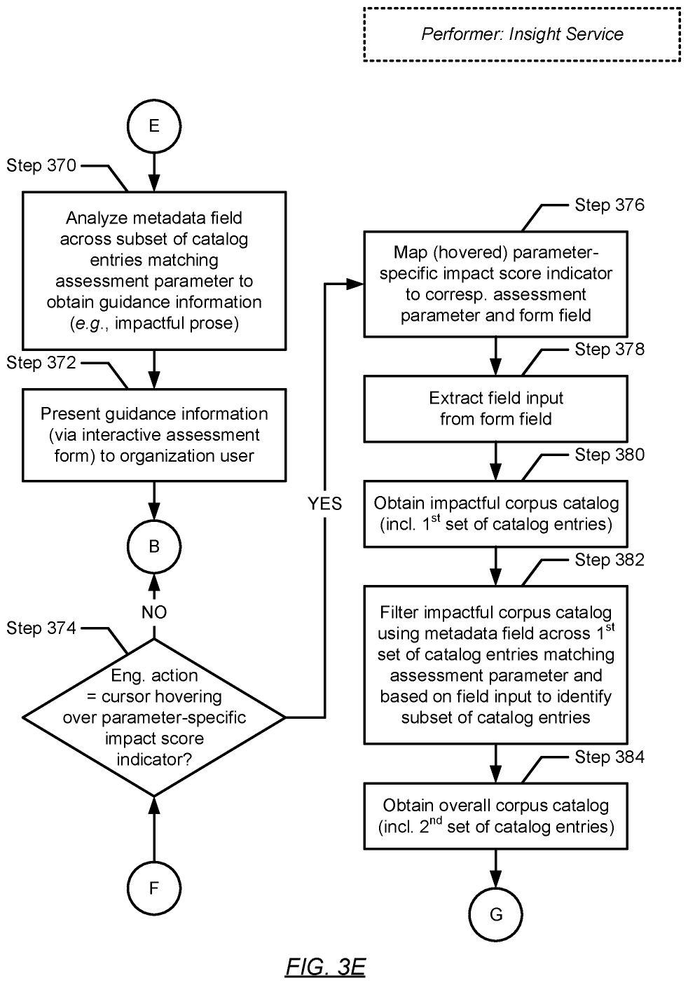

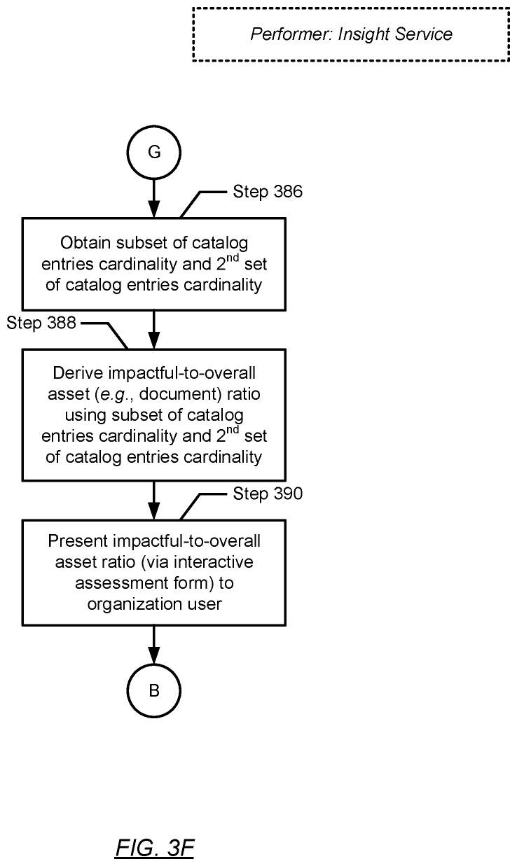

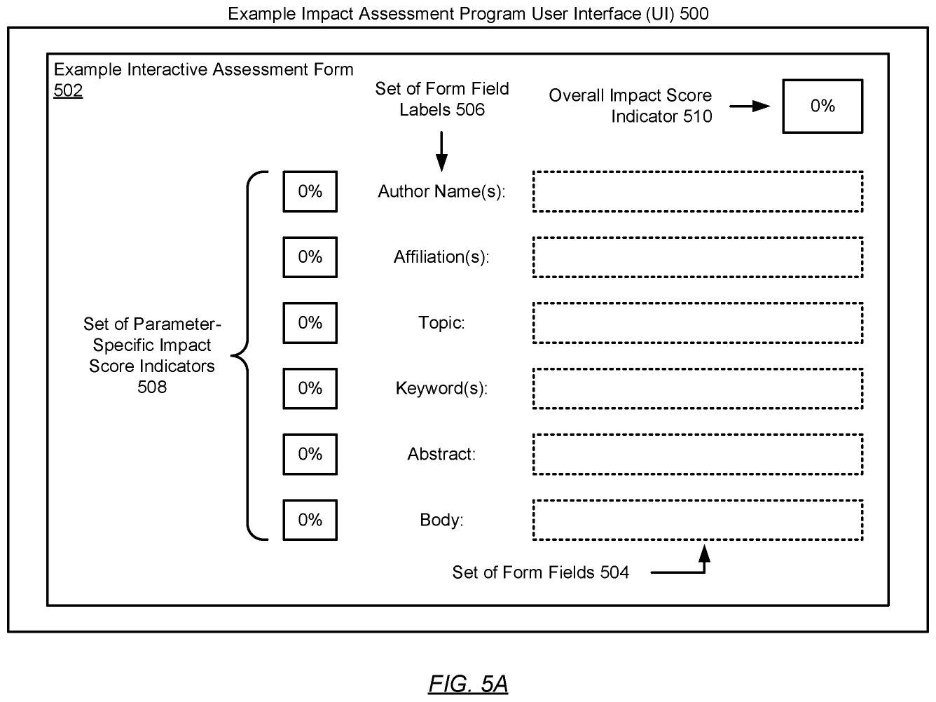

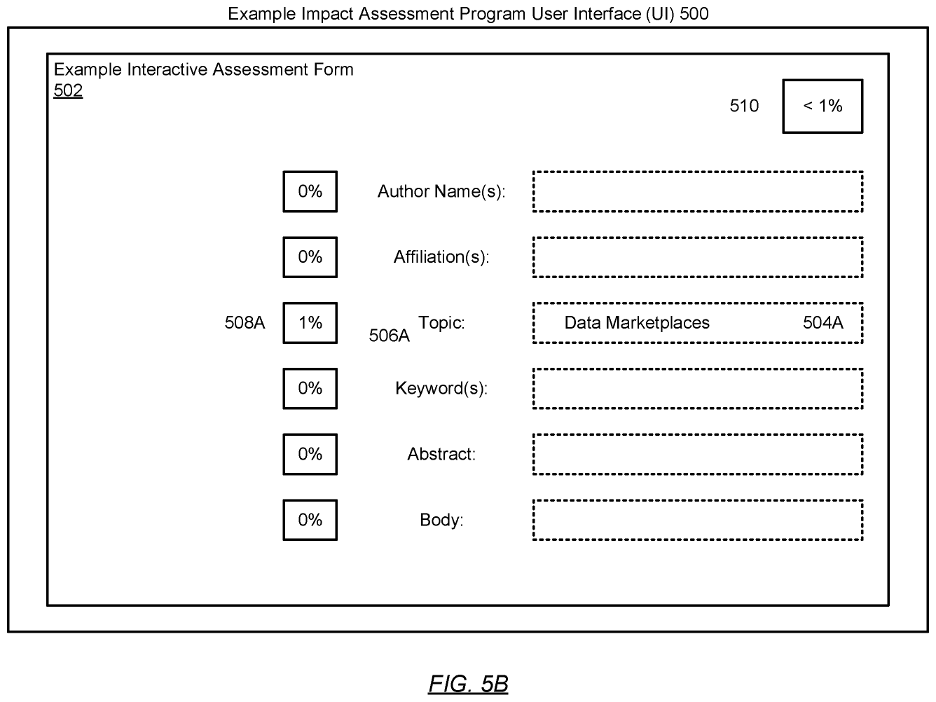

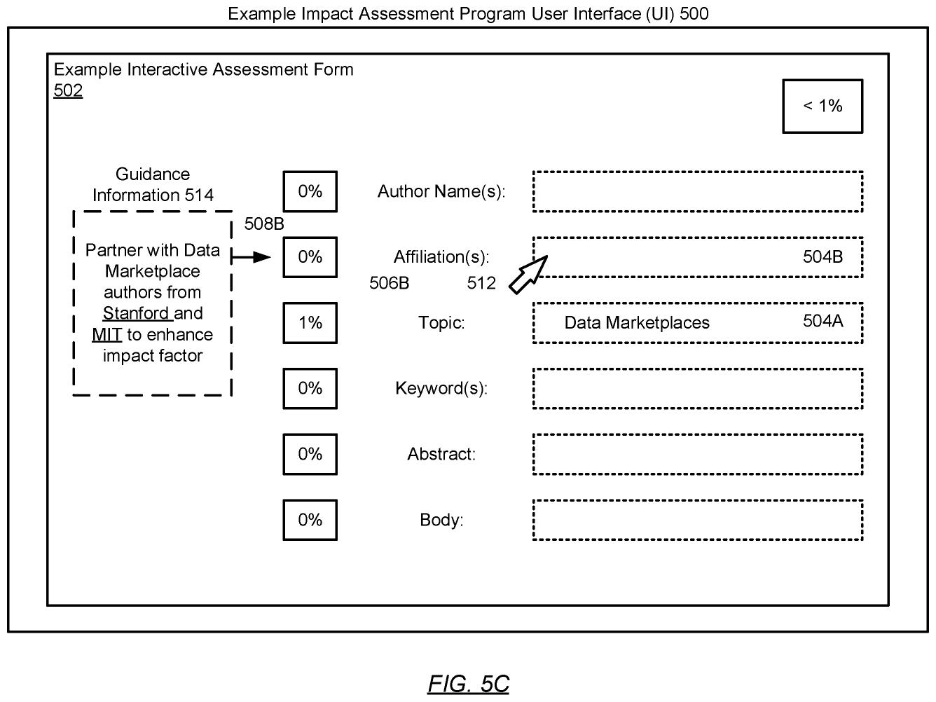

In one or many embodiment(s) disclosed herein, the insight service (106) may be configured with various capabilities or functionalities directed to digitally-assisted organization strategy. Said capabilities/functionalities may include: impact enhancing recommendations for research papers and initiatives, as described in FIGS. 3A-3F as well as exemplified in FIGS. 5A-5C, below. Further, the insight service (106) may perform other capabilities/functionalities without departing from the scope disclosed herein.

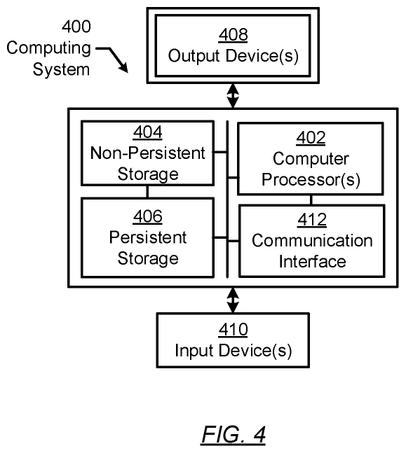

In one or many embodiment(s) disclosed herein, the insight service (106) may be implemented through on-premises infrastructure, cloud computing infrastructure, or any hybrid infrastructure thereof. The insight service (106), accordingly, may be implemented using one or more network servers (not shown), where each network server may represent a physical or a virtual network server. Additionally, or alternatively, the insight service (106) may be implemented using one or more computing systems each similar to the example computing system shown and described with respect to FIG. 4, below.

In one or many embodiment(s) disclosed herein, a client device (108) may represent any physical appliance or computing system operated by one or more organization users and configured to receive, generate, process, store, and/or transmit data/information (e.g., assets), as well as to provide an environment in which one or more computer programs (e.g., applications, insight agents, etc.) may execute thereon. An organization user, briefly, may refer to any individual whom is affiliated with, and fulfills one or more roles pertaining to, the organization that serves as the proprietor of the organization-internal environment (102). Further, in providing an execution environment for any computer programs, a client device (108) may include and allocate various resources (e.g., computer processors, memory, storage, virtualization, network bandwidth, etc.), as needed, to the computer programs and the tasks (or processes) instantiated thereby. Examples of a client device (108) may include, but are not limited to, a desktop computer, a laptop computer, a tablet computer, a smartphone, or any other computing system similar to the example computing system shown and described with respect to FIG. 4, below. Moreover, any client device (108) is described in further detail through FIG. 1B, below.

In one or many embodiment(s) disclosed herein, the organization-external environment (110) may represent any number of digital (e.g., IT) ecosystems not belonging to, and thus not managed by, an/the organization serving as the proprietor of the organization-internal environment (102). The organization-external environment (110), accordingly, may at least reference any public networks including any respective service(s) and data/information (e.g., assets). Further, the organization-external environment (110) may include one or more external data sources (112) and one or more third-party services (114). Each of these organization-external environment (110) subcomponents may or may not be co-located, and thus reside and/or operate, in the same physical or geographical space. Moreover, each of these organization-external environment (110) subcomponents is described below.

In one or many embodiment(s) disclosed herein, an external data source (112) may represent any data source (described above) not belonging to, and thus not managed by, an/the organization serving as the proprietor of the organization-internal environment (102). Any external data source (112), more specially, may refer to a location that stores at least a portion of the asset(s) found across any public networks. Further, depending on their respective access permissions, entities within the organization-internal environment (102), as well as those throughout the organization-external environment (110), may or may not be permitted to access any external data source (104) and, therefore, may or may not be permitted to access any asset(s) maintained therein.

Moreover, in one or many embodiment(s) disclosed herein, any external data source (112) may be implemented as physical storage (and/or as logical/virtual storage spanning at least a portion of the physical storage). The physical storage may, at least in part, include persistent storage, where examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) disclosed herein, a third party service (114) may represent information technology infrastructure configured for any number of purposes and/or applications. A third party, whom may implement and manage one or more third party services (114), may refer to an individual, a group of individuals, or another organization (i.e., not the organization serving as the proprietor of the organization-internal environment (102)) that serves as the proprietor of said third party service(s) (114). By way of an example, one such third party service (114), as disclosed herein may be exemplified by an automated machine learning (ML) service. A purpose of the automated ML service may be directed to automating the selection, composition, and parameterization of ML models. That is, more simply, the automated ML service may be configured to automatically identify one or more optimal ML algorithms from which one or more ML models may be constructed and fit to a submitted dataset in order to best achieve any given set of tasks. Further, any third party service (114) is not limited to the aforementioned specific example.

In one or many embodiment(s) disclosed herein, any third party service (114) may be implemented through on-premises infrastructure, cloud computing infrastructure, or any hybrid infrastructure thereof. Any third party service (114), accordingly, may be implemented using one or more network servers (not shown), where each network server may represent a physical or a virtual network server. Additionally, or alternatively, any third party service (114) may be implemented using one or more computing systems each similar to the example computing system shown and described with respect to FIG. 4, below.

In one or many embodiment(s) disclosed herein, the above-mentioned system (100) components, and their respective subcomponents, may communicate with one another through a network (not shown) (e.g., a local area network (LAN), a wide area network (WAN) such as the Internet, a mobile network, any other communication network type, or a combination thereof). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components and their respective subcomponents. Moreover, in communicating with one another, the above-mentioned system (100) components, and their respective subcomponents, may employ any combination of existing wired and/or wireless communication protocols.

While FIG. 1A shows a configuration of components and/or subcomponents, other system (100) configurations may be used without departing from the scope disclosed herein.

FIG. 1B shows a client device in accordance with one or more embodiments disclosed herein. The client device (108) (described above as well) (see e.g., FIG. 1A) may host or include one or more applications (116A-116N). Each application (116A-116N), in turn, may host or include an insight agent (118A-118N). Each of these client device (108) subcomponents is described below.

In one or many embodiment(s) disclosed herein, an application (116A-116N) (also referred to herein as a software application or program) may represent a computer program, or a collection of computer instructions, configured to perform one or more specific functions. Broadly, examples of said specific function(s) may include, but are not limited to, receiving, generating and/or modifying, processing and/or analyzing, storing or deleting, and transmitting data/information (e.g., assets) (or at least portions thereof). That is, said specific function(s) may generally entail one or more interactions with data/information either maintained locally on the client device (108) or remotely across one or more data sources. Examples of an application (116A-116N) may include a word processor, a spreadsheet editor, a presentation editor, a database manager, a graphics renderer, a video editor, an audio editor, a web browser, a collaboration tool or platform, and an electronic mail (or email) client. Any application (116A-116N), further, is not limited to the aforementioned specific examples.

In one or many embodiment(s) disclosed herein, any application (116A-116N) may be employed by one or more organization users, which may be operating the client device (108), to achieve one or more tasks, at least in part, contingent on the specific function(s) that the application (116A-116N) may be configured to perform. Said task(s) may or may not be directed to supporting and/or achieving any short-term and/or long-term goal(s) outlined by an/the organization with which the organization user(s) may be affiliated.

In one or many embodiment(s) disclosed herein, an insight agent (118A-118N) may represent a computer program, or a collection of computer instructions, configured to perform any number of tasks in support, or as extensions, of the capabilities or functionalities of the insight service (106) (described above) (see e.g., FIG. 1A). With respect to their assigned application (116A-116N), examples of said tasks, which may be carried out by a given insight agent (118A-118N), may include: detecting an initiation of their assigned application (116A-116N) by the organization user(s) operating the client device (108); monitoring any engagement (or interaction), by the organization user(s), with their assigned application (116A-116N) following the detected initiation thereof; identifying certain engagement/interaction actions, performed by the organization user(s), based on said engagement/interaction monitoring; executing any number of procedures or algorithms, relevant to one or more insight service (106) capabilities/functionalities, in response to one or more of the identified certain engagement/interaction actions; providing periodic and/or on-demand telemetry to the insight service (106), where said telemetry may include, for example, data/information requiring processing or analysis to be performed on/by the insight service (106); and receive periodic and/or on-demand updates (and/or instructions) from the insight service (106). Further, the tasks carried out by any insight agent (118A-118N) are not limited to the aforementioned specific examples.

While FIG. 1B shows a configuration of components and/or subcomponents, other client device (108) configurations may be used without departing from the scope disclosed herein. For example, in one or many embodiment(s) disclosed herein, not all of the application(s) (116A-116N), executing on the client device (108), may host or include an insight agent (118A-118N). That is, in said embodiment(s), an insight agent (118A-118N) may not be assigned to or associated with any of at least a subset of the application(s) (116A-116N) installed on the client device (108).

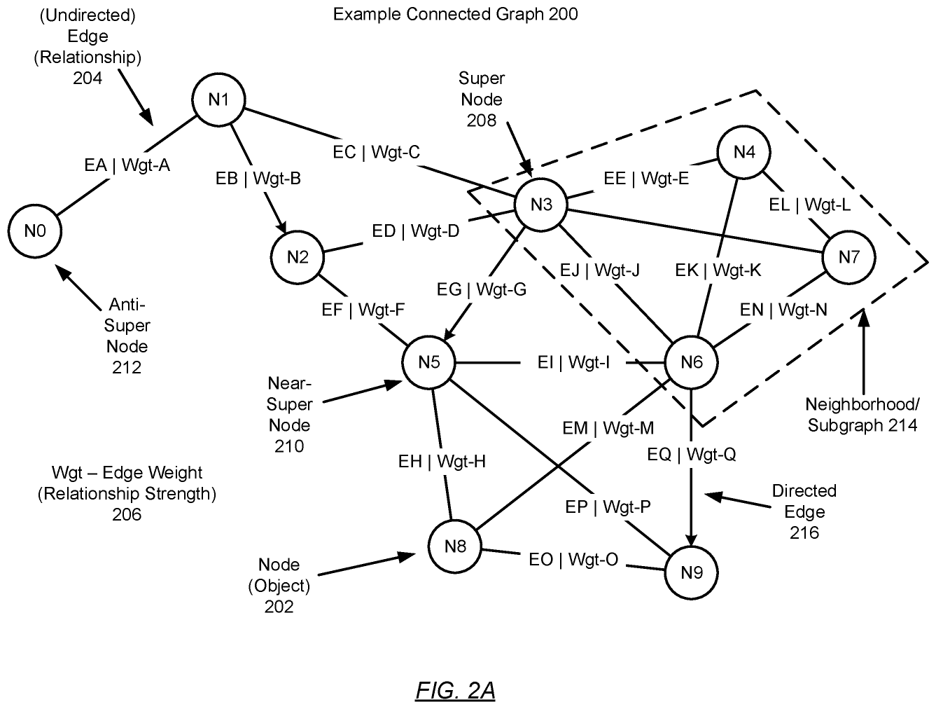

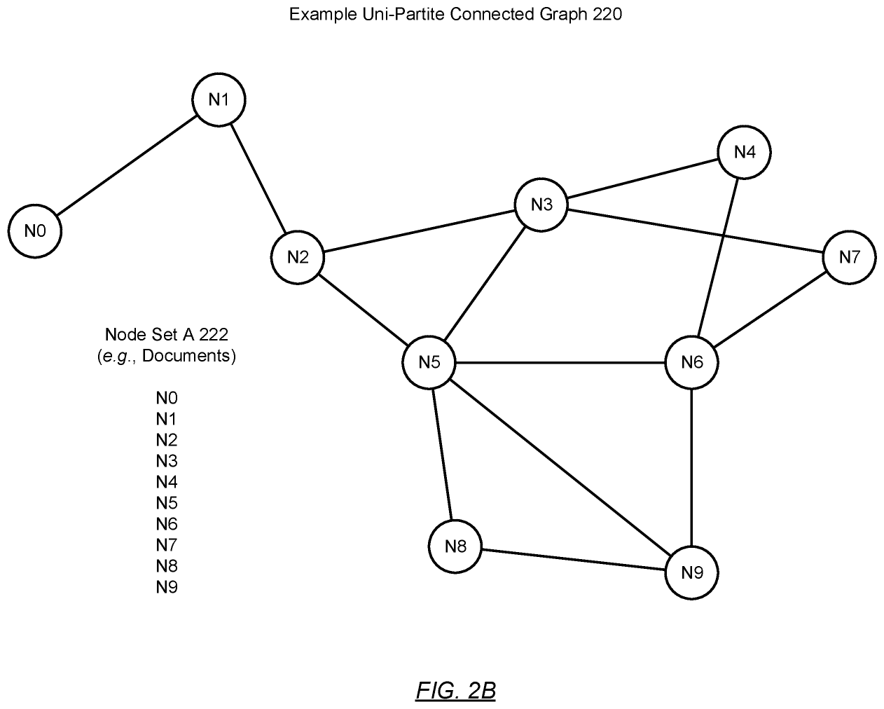

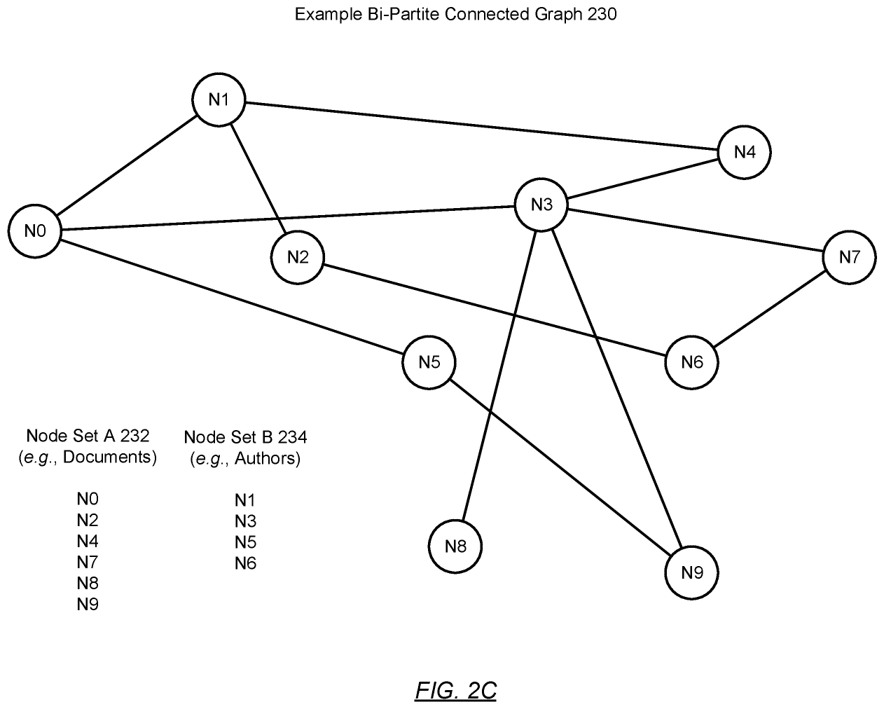

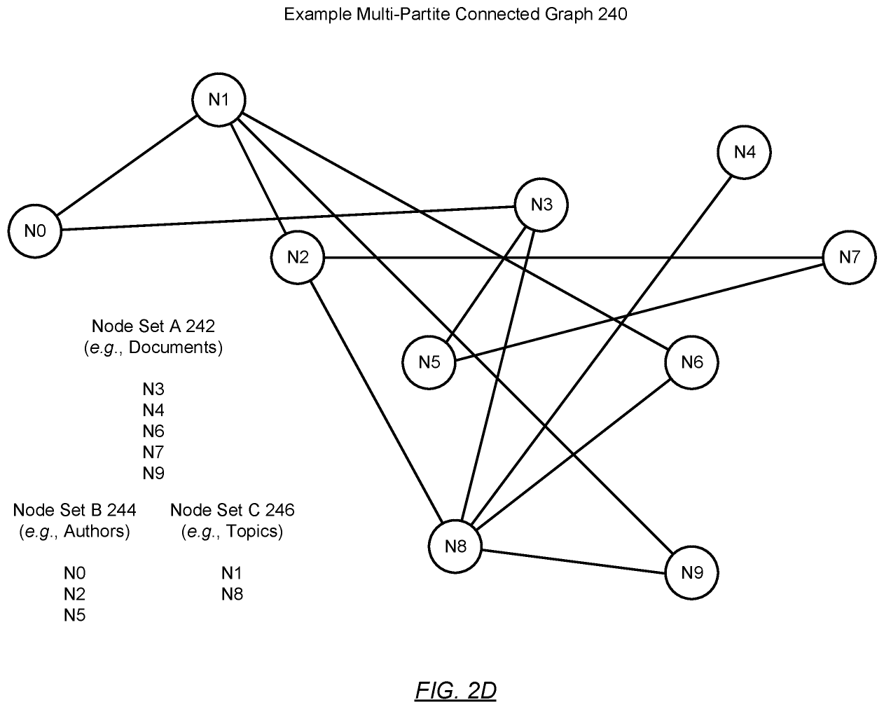

FIG. 2A shows an example connected graph in accordance with one or more embodiments disclosed herein. A connected graph (200), as disclosed herein, may refer to a set of nodes (202) (denoted in the example by the circles labeled N0, N1, N2, . . . , N9) interconnected by a set of edges (204, 216) (denoted in the example by the lines labeled EA, EB, EC, . . . , EQ between pairs of nodes). Each node (202) may represent or correspond to an object (e.g., a catalog entry, a record, specific data/information, a person, etc.) whereas each edge (204, 216), between or connecting any pair of nodes, may represent or correspond to a relationship, or relationships, associating the objects mapped to the pair of nodes. A connected graph (200), accordingly, may reference a data structure that reflects associations amongst any number, or a collection, of objects.

In one or many embodiment(s) disclosed herein, each node (202), in a connected graph (200), may also be referred to herein, and thus may serve, as an endpoint (of a pair of endpoints) of/to at least one edge (204). Further, based on a number of edges connected thereto, any node (202), in a connected graph (200), may be designated or identified as a super node (208), a near-super node (210), or an anti-super node (212). A super node (208) may reference any node where the number of edges, connected thereto, meets or exceeds a (high) threshold number of edges (e.g., six (6) edges). A near-super node (210), meanwhile, may reference any node where the number of edges, connected thereto, meets or exceeds a first (high) threshold number of edges (e.g., five (5) edges) yet lies below a second (higher) threshold number of edges (e.g., six (6) edges), where said second threshold number of edges defines the criterion for designating/identifying a super node (208). Lastly, an anti-super node (212) may reference any node where the number of edges, connected thereto, lies below a (low) threshold number of edges (e.g., two (2) edges).

In one or many embodiment(s) disclosed herein, each edge (204, 216), in a connected graph (200), may either be designated or identified as an undirected edge (204) or, conversely, as a directed edge (216). An undirected edge (204) may reference any edge specifying a bidirectional relationship between objects mapped to the pair of endpoints (i.e., pair of nodes (202)) connected by the edge. A directed edge (216), on the other hand, may reference any edge specifying a unidirectional relationship between objects mapped to the pair of endpoints connected by the edge.

In one or many embodiment(s) disclosed herein, each edge (204, 216), in a connected graph (200), may be associated with or assigned an edge weight (206) (denoted in the example by the labels Wgt-A, Wgt-B, Wgt-C, . . . . , Wgt-Q). An edge weight (206), of a given edge (204, 216), may reflect a strength of the relationship(s) represented by the given edge (204, 216). Further, any edge weight (206) may be expressed as or through a positive numerical value within a predefined spectrum or range of positive numerical values (e.g., 0.1 to 1.0, 1 to 100, etc.). Moreover, across the said predefined spectrum/range of positive numerical values, higher positive numerical values may reflect stronger relationships, while lower positive numerical values may alternatively reflect weaker relationships.

In one or many embodiment(s) disclosed herein, based on an edge weight (206) associated with or assigned to an edge (204, 216) connected thereto, any node (202), in a connected graph (200), may be designated or identified as a strong adjacent node (not shown) or a weak adjacent node (not shown) with respect to the other endpoint of (i.e., the other node connected to the node (202) through) the edge (204, 216). That is, a strong adjacent node may reference any node of a pair of nodes connected by an edge, where an edge weight of the edge meets or exceeds a (high) edge weight threshold. Alternatively, a weak adjacent node may reference any node of a pair of nodes connected by an edge, where an edge weight of the edge lies below a (low) edge weight threshold.

In one or many embodiment(s) disclosed herein, a connected graph (200) may include one or more subgraphs (214) (also referred to as neighborhoods). A subgraph (214) may refer to a smaller connected graph found within a (larger) connected graph (200). A subgraph (214), accordingly, may include a node subset of the set of nodes (202), and an edge subset of the set of edges (204, 216), that form a connected graph (200), where the edge subset interconnects the node subset.

While FIG. 2A shows a configuration of components and/or subcomponents, other connected graph (200) configurations may be used without departing from the scope disclosed herein.

FIGS. 2B-2D show example k-partite connected graphs in accordance with one or more embodiments disclosed herein. Generally, any k-partite connected graph may represent a connected graph (described above) (see e.g., FIG. 2A) that encompasses k independent sets of nodes and a set of edges interconnecting (and thus defining relationships between) pairs of nodes: (a) both belonging to the same, single independent set of nodes in any (k=1)-partite connected graph; or (b) each belonging to a different independent set of nodes in any (k>1)-partite connected graph. Further, any k-partite connected graph, as disclosed herein, may fall into one of three possible classifications: (a) a uni-partite connected graph, where k=1; (b) a bi-partite connected graph, where k=2; or (c) a multi-partite connected graph, where k≥3.

Turning to FIG. 2B, an example uni-partite connected graph (220) is depicted. The uni-partite connected graph (220) includes one (k=1) independent set of nodes—i.e., a node set (222), which collectively maps or belongs to a single object class (e.g., documents).

Further, in the example, the node set is denoted by the circles labeled NO, N1, N2, . . . , N9. Each said circle, in the node set (222), subsequently denotes a node that represents or corresponds to a given object (e.g., a document) in a collection of objects (e.g., a group of documents) of the same object class (e.g., documents).

Moreover, the uni-partite connected graph (220) additionally includes a set of edges (denoted in the example by the lines interconnecting pairs of nodes, where the first and second nodes in a given node pair belongs to the node set (222)). Each edge, in the example, thus reflects a relationship, or relationships, between any two nodes of the node set (222) (and, by association, any two objects of the same object class) directly connected via the edge.

Turning to FIG. 2C, an example bi-partite connected graph (230) is depicted. The bi-partite connected graph (230) includes two (k=2) independent sets of nodes—i.e., a first node set (232) and a second node set (234), where the former collectively maps or belongs to a first object class (e.g., documents) whereas the latter collectively maps or belongs to a second object class (e.g., authors).

Further, in the example, the first node set (232) is denoted by the circles labeled NO, N2, N4, N7, N8, and N9, while the second node set (234) is denoted by the circles labeled N1, N3, N5, and N6. Each circle, in the first node set (232), subsequently denotes a node that represents or corresponds to a given first object (e.g., a document) in a collection of first objects (e.g., a group of documents) of the first object class (e.g., documents). Meanwhile, each circle, in the second node set (234), subsequently denotes a node that represents or corresponds to a given second object (e.g., an author) in a collection of second objects (e.g., a group of authors) of the second object class (e.g., authors).

Moreover, the bi-partite connected graph (230) additionally includes a set of edges (denoted in the example by the lines interconnecting pairs of nodes, where a first node in a given node pair belongs to the first node set (232) and a second node in the given node pair belongs to the second node set (234)). Each edge, in the example, thus reflects a relationship, or relationships, between any one node of the first node set (232) and any one node of the second node set (234) (and, by association, any one object of the first object class and any one object of the second object class) directly connected via the edge.

Turning to FIG. 2D, an example multi-partite connected graph (240) is depicted. The multi-partite connected graph (240) includes three (k=3) independent sets of nodes—i.e., a first node set (242), a second node set (244), and a third node set (246). The first node set (242) collectively maps or belongs to a first object class (e.g., documents); the second node set (244) collectively maps or belongs to a second object class (e.g., authors); and the third node set (246) collectively maps or belongs to a third object class (e.g., topics).

Further, in the example, the first node set (242) is denoted by the circles labeled N3, N4, N6, N7, and N9; the second node set (244) is denoted by the circles labeled NO, N2, and N5; and the third node set (246) is denoted by the circles labeled N1 and N8. Each circle, in the first node set (242), subsequently denotes a node that represents or corresponds to a given first object (e.g., a document) in a collection of first objects (e.g., a group of documents) of the first object class (e.g., documents). Meanwhile, each circle, in the second node set (244), subsequently denotes a node that represents or corresponds to a given second object (e.g., an author) in a collection of second objects (e.g., a group of authors) of the second object class (e.g., authors). Lastly, each circle, in the third node set (246), subsequently denotes a node that represents or corresponds to a given third object (e.g., a topic) in a collection of third objects (e.g., a group of topics) of the third object class (e.g., topics).

Moreover, the multi-partite connected graph (240) additionally includes a set of edges (denoted in the example by the lines interconnecting pairs of nodes, where a first node in a given node pair belongs to one object class from the three available object classes, and a second node in the given node pair belongs to another object class from the two remaining object classes (that excludes the one object class to which the first node in the given node pair belongs)). Each edge, in the example, thus reflects a relationship, or relationships, between any one node of one object class (from the three available object classes) and any one node of another object class (from the two remaining object class excluding the one object class) directly connected via the edge.

FIGS. 3A-3F show flowcharts describing a method for impact enhancing recommendations for research papers and initiatives in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 3A, in Step 300, an initiation of an impact assessment program, by an organization user, is detected. In one or many embodiment(s) disclosed herein, the impact assessment program may refer to any software application configured to evaluate unbegun research (e.g., a research paper that has yet to be drafted or a research initiative that has yet to be pursued) and, subsequently, provide guidance with respect to enhancing an impact factor of said unbegun research. The impact factor, in turn, may refer to a measure of the prospective usefulness and/or success of the unbegun research to, for example, stimulate advances in technology development and/or steer the overall direction of one or more industries. Further, detection of the initiation of the impact assessment program may, for example, involve the receiving of telemetry from one or more insight agents (see e.g., FIG. 1B) executing on a client device operated by the organization user, where the impact assessment program also executes on the aforementioned client device. The insight agent(s), accordingly, may be embedded within, or may otherwise be associated with, the impact assessment program.

In Step 302, a set of assessment parameters is/are obtained. In one or many embodiment(s) disclosed herein, an assessment parameter may refer to metadata descriptive, and thus also a point of assessment, of any unbegun research. Examples of an assessment parameter, as pertaining to the description and/or evaluation of a given unbegun research, may include: (a) a number of authors associated with the given unbegun research; (b) one or more author names each belonging to an author associated with the given unbegun research; (c) one or more organizations (e.g., a business/commercial entity, a higher education school, a government agency, a research institute, etc.) with which the author(s), associated with the given unbegun research, may be affiliated; (d) one or more geographical locations (e.g., cities, states, and/or countries) within which the author(s), associated with the given unbegun research, may reside; (e) an abstract summarizing the given unbegun research; (f) one or more keywords pertaining to the given unbegun research; (g) one or more topics on which the given unbegun research may be centered; (h) an introduction, associated with, and capturing a scope, a context, and/or a significance of, the given unbegun research; (i) a body, associated with, and capturing a hypothesis (or argument) and/or a methodology of, the given unbegun research; (j) a conclusion associated with, and capturing one or more key points of, the given unbegun research; (k) one or more contributor names (e.g., representative of acknowledgements) each belonging to a contributor whom may aid in a carrying out of the given unbegun research; and (1) one or more references (or citations) to other research work reflective of a source, or sources, of the given unbegun research (or at least a portion thereof). Further, any assessment parameter is not limited to the aforementioned specific examples.

In Step 304, an interactive assessment form is instantiated. In one or many embodiment(s) disclosed herein, an interactive form may generally refer to an electronic document that responds to engagement, or interaction, from/by a user. As such, the interactive assessment form may reference an interactive form, aiming to determine and enhance an impact factor (described above) for any given unbegun research, which responds to engagement/interaction thereof from/by the organization user. Further, instantiation of the interactive assessment form may be contingent on the set of assessment parameters (obtained in Step 302). That is, the set of assessment parameters may influence, for example, a structure/presentation and/or a response functionality of the interactive assessment form. The interactive assessment form, moreover, may be implemented through a collection of interactive form components.

In one or many embodiment(s) disclosed herein, the interactive assessment form may include, and thus may visually convey, a set of form fields (e.g., a set of interactive form components). Any form field may represent an editable text field wherein the organization user may enter (or input) and/or edit text of any arbitrary length. Further, each form field, in the set of form fields, may map or correspond to an assessment parameter in the set of assessment parameters (obtained in Step 302). Accordingly, any (editable) text (also referred to herein as a field input), which may be entered/inputted and/or edited by the organization user within a given form field, may recite information pertaining to or capturing a given assessment parameter to which the given form field maps/corresponds.

In one or many embodiment(s) disclosed herein, any form field, in the set of form fields, may be associated with a form field status thereof. The form field status of any given form field may thus reflect a state thereof based on the (editable) text (if any) specified there-within. By way of an example, should no (editable) text (e.g., zero characters of text) be present or specified within a given form field, then the form field status thereof may reflect that the given form field is in an empty state (and, therefore, the given form field may be representative of an empty form field). Conversely, by way of another example, should at least one character of text be present or specified within a given form field, then the form field status thereof may reflect that the given form field is in a non-empty state (and, therefore, the given form field may be representative of a non-empty form field).

In one or many embodiment(s) disclosed herein, any form field, in the set of form fields, may further be associated with a form field class thereof. The form field class of any given form field may reflect a complexity of the given assessment parameter to which the given form field maps/corresponds. In turn, a complexity of a given assessment parameter may be measured, for example, by way of the length, and/or the extent of the effort contributive, of the (editable) text expected to be entered/inputted and/or edited, within the given form field by the organization user, where said (editable) text sufficiently captures the context of the given assessment parameter. Further, as disclosed herein, any given form field may be associated with one of two possible form field classes—i.e., a simple form field class reflective of any form field predefined as a simple form field, and a complex form field class reflective of any form field predefined as a complex form field. From the above-listed example assessment parameters (see e.g., Step 302), a subset thereof, mapping/corresponding to a simple form field, may include: the number of authors; the author name(s); the affiliated organization(s); the geographical location(s); the keyword(s); the topic(s); and the contributor name(s). Conversely, from the above-listed example assessment parameters, another subset thereof, mapping/corresponding to a complex form field, may include: the abstract; the introduction; the body; the conclusion; and the reference(s).

In one or many embodiment(s) disclosed herein, the interactive assessment form may include, and thus may visually convey, a set of form field labels (e.g., a set of interactive form components). Any form field label may represent a static text field that cannot be altered by the organization user. Further, each form field label, in the set of form field labels, may map or correspond to an assessment parameter in the set of assessment parameters (obtained in Step 302) (and, by association, may also map or correspond to a respective form field in the set of form fields). Accordingly, any (static) text, representative of a given form field label, may recite a human-readable identifier or name for a given assessment parameter, as well as hint at the information expected to be entered/inputted and/or edited by the organization user within a given form field, to which the given form field label maps/corresponds.

In one or many embodiment(s) disclosed herein, the interactive assessment form may include, and thus may visually convey, a set of parameter-specific impact score indicators (e.g., a set of interactive form components). Any parameter-specific impact score indicator may represent a response-driven text field that cannot be altered by the organization user, however, any displayed text (e.g., reflective of a parameter-specific impact score) therein can nevertheless change in response to one or more interactions, by the organization user, with the interactive assessment form. Further, each parameter-specific impact score indicator, in the set of parameter-specific impact score indicators, may map or correspond to an assessment parameter in the set of assessment parameters (obtained in Step 302) (and, by association, may also map or correspond to a respective form field in the set of form fields, as well as a respective form field label in the set of form field labels). Moreover, any parameter-specific impact score, which may be displayed through any given parameter-specific impact score indicator, may refer to an item of information (e.g., usually expressed as a positive numerical value or a percentage value) that conveys a partial impact factor of an unbegun research being currently evaluated using the interactive assessment form. The partial impact factor, in turn, may measure a prospective usefulness and/or success of the unbegun research as said prospective usefulness and/or success pertains to (or considers) a particular assessment parameter (e.g., the assessment parameter to which the given parameter-specific impact score indicator maps/corresponds).

In one or many embodiment(s) disclosed herein, the interactive assessment form may include, and thus may visually convey, an overall impact score indicator (e.g., an interactive form component). The overall impact score indicator may represent a response-driven text field that cannot be altered by the organization user, however, any displayed text (e.g., reflective of an overall impact score) therein can nevertheless change in response to one or more interactions, by the organization user, with the interactive assessment form. Further, the overall impact score may refer to an item of information (e.g., usually expressed as a positive numerical value or a percentage value) that conveys a total impact factor of an unbegun research being currently evaluated using the interactive assessment form. The total impact factor, in turn, may measure a prospective usefulness and/or success of the unbegun research as said prospective usefulness and/or success pertains to (or considers) all assessment parameters in the set of assessment parameters (obtained in Step 302).

For an example interactive assessment form, including examples of the above-described interactive form components, refer to the example scenario illustrated and discussed with respect to FIG. 5A-5C, below. Furthermore, any interactive assessment form, as disclosed herein, is not limited to being composed of/by any combination of the above-described interactive form components.

In Step 306, the interactive assessment form (instantiated in Step 304) is subsequently presented/provided to the organization user. In one or many embodiment(s) disclosed herein, the interactive assessment form, more specifically, may be presented by way of the impact assessment program.

In Step 308, following a presentation of the interactive assessment form (in Step 306), following a presentation of guidance information (in Step 332 or Step 372) (described below—see e.g., FIG. 3B or FIG. 3E), following an updating of the interactive assessment form (in Step 350) (described below—see e.g., FIG. 3C), following an alternative determination (made in Step 374) (described below—see e.g., FIG. 3E) that any engagement action hovers (using a cursor) over any given parameter-specific impact score indicator, or following a presentation of an impactful-to-overall asset ratio (in Step 390) (described below—see e.g., FIG. 3F), engagement (or interaction) with the interactive assessment form (presented in Step 306) is monitored. In one or many embodiment(s) disclosed herein, said engagement/interaction may be performed by the organization user whom initiated the impact assessment program (detected in Step 300) and may refer to any number of engagement actions through which the organization user interacts with, or employs one or more features of, the interactive assessment form. Examples of said engagement actions may include, but are not limited to, terminating the impact assessment program (and, by association, the interactive assessment form), hovering (using a cursor) over any form field, editing any simple form field, editing any complex form field, and hovering (using a cursor) over any parameter-specific impact score indicator. The organization user may interact with the interactive assessment form, and/or the impact assessment program, through other engagement actions not explicitly described hereinafter without departing from the scope disclosed herein.

In Step 310, based on the interactive assessment form engagement/interaction (monitored in Step 308), a determination is made as to whether any engagement action reflects a terminating of the impact assessment program. The organization user may terminate the impact assessment program (and thus the interactive assessment form) by, for example, closing a user interface for, associated with, or representative of the impact assessment program. As such, in one or many embodiment(s) disclosed herein, if it is determined that any engagement action terminates the impact assessment program, then the method ends. On the other hand, in one or many other embodiment(s) disclosed herein, if it is alternatively determined that any engagement action does not terminate the impact assessment program, then the method alternatively proceeds to Step 312.

In Step 312, following the determination (made in Step 310) that any engagement action, based on the interactive assessment form engagement/interaction (monitored in Step 308), does not terminate the impact assessment program, a determination is made as to whether said any engagement action reflects a hovering (using a cursor) of any given form field. As such, in one or more embodiment(s) disclosed herein, if it is determined that any engagement action hovers over any given form field, then the method proceeds to Step 314. On the other hand, in one or many other embodiment(s) disclosed herein, if it is alternatively determined that any engagement action does not hover over any given form field, then the method alternatively proceeds to Step 334 (see e.g., FIG. 3C).

In Step 314, following the determination (made in Step 312) that any engagement action, based on the interactive assessment form engagement/interaction (monitored in Step 308), hovers (using a cursor) over any given form field, a guiding assessment parameter is identified. In one or many embodiment(s) disclosed herein, said guiding assessment parameter may represent a/the assessment parameter to which the given form field maps/corresponds.

From Step 314, the method proceeds to Step 316 (see e.g., FIG. 3B).

Turning to FIG. 3B, in Step 316, an impactful corpus catalog is obtained. In one or many embodiment(s) disclosed herein, the impactful corpus catalog may represent a data structure that maintains asset metadata describing, and thus pertaining to, a collection of impactful assets forming an impactful corpus. Each (impactful) asset in the impactful corpus may refer to any research-centered and predominantly text-based item of information (e.g., a research paper, a research thesis, a research proposal, etc.) that, over time, has, for example, positively impacted, influenced, or steered: other (future) research work in a same research space, or in one or more adjacent research spaces, as that associated with the asset; one or more advances in technology; and/or an overall direction of one or more industries. Furthermore, the asset metadata, maintained in the impactful corpus catalog, may be organized across a set of (impactful corpus) catalog entries. Each (impactful corpus) catalog entry, in the set of (impactful corpus) catalog entries, may pertain to an (impactful) asset in the impactful corpus and, therefore, may store asset metadata particular to said (impactful) asset. Further, any asset metadata may be divided into a set of metadata fields, where each metadata field further organizes the asset metadata based on a given context.

Examples of asset metadata, for any given (impactful) asset, may include the following context(s) (i.e., metadata field(s)): (a) a number of authors associated with the given (impactful) asset; (b) one or more author names each belonging to an author associated with the given (impactful) asset; (c) one or more organizations (e.g., a business/commercial entity, a higher education school, a government agency, a research institute, etc.) with which the author(s), associated with the given (impactful) asset, may be affiliated; (d) one or more geographical locations (e.g., cities, states, and/or countries) within which the author(s), associated with the given (impactful) asset, may reside; (e) an abstract summarizing the given (impactful) asset; (f) one or more keywords pertaining to the given (impactful) asset; (g) one or more topics on which the given (impactful) asset may be centered; (h) an introduction, associated with, and capturing a scope, a context, and/or a significance of, the given (impactful) asset; (i) a body, associated with, and capturing a hypothesis (or argument) and/or a methodology of, the given (impactful) asset; (j) a conclusion associated with, and capturing one or more key points of, the given (impactful) asset; (k) one or more contributor names (e.g., representative of acknowledgements) each belonging to a contributor whom may have aided in a carrying out of the given (impactful) asset; and (1) one or more references (or citations) to other research work reflective of a source, or sources, of the given (impactful) asset (or at least a portion thereof). Further, asset metadata is not limited to the aforementioned specific (metadata field) examples.

In Step 318, a search, across or involving the set of form fields, at least in part, composing the interactive assessment form (presented in Step 306), is performed. In one or many embodiment(s) disclosed herein, the search may attempt to identify any non-empty form fields (described above—see e.g., Step 304) in the set of form fields.

In Step 320, a determination is made, based on the search (performed in Step 318), as to whether at least one non-empty form field, in the set of form fields, at least in part, composing the interactive assessment form (presented in Step 306), had been identified. As such, in one or many embodiment(s) disclosed herein, if it is determined that said search succeeded in identifying at least one non-empty form field, then the method proceeds to Step 322. On the other hand, in one or many other embodiment(s) disclosed herein, if it is alternatively determined that said search failed in identifying at least one non-empty form field, then the method alternatively proceeds to Step 328.

In Step 322, following the determination (made in Step 320) that the search (performed in Step 318) succeeded in identifying at least one non-empty form field, a field input, for each non-empty form field in the at least one non-empty form field, is extracted therefrom (thereby obtaining at least one field input). In one or many embodiment(s) disclosed herein, the field input, for any given non-empty form field, may refer to the (editable) text found within the given form field, which the organization user, at some prior point-in-time, had entered/inputted and/or edited there-within.

In Step 324, at least one filtering assessment parameter is identified. In one or many embodiment(s) disclosed herein, each filtering assessment parameter, in the at least one filtering assessment parameter, may refer to an assessment parameter, in the set of assessment parameters (obtained in Step 302). Further, identification of each filtering assessment parameter may entail mapping a non-empty form field, in the at least one non-empty form field (identified via the search performed in Step 318), to their respective assessment parameter.

In Step 326, the impactful corpus catalog (obtained in Step 316) is filtered at least based on the at least one field input (obtained in Step 322). In one or many embodiment(s) disclosed herein, filtering of the impactful corpus catalog may, for example, entail topic matching (e.g., case-insensitive word or phrase matching) and/or semantic similarity calculation between the at least one field input (or each field input therein) and the asset metadata, for (impactful) assets, maintained across the (impactful corpus) catalog entries of the impactful corpus catalog. Further, said filtering may result in the identification of a catalog entry subset in (or a subset of) the set of catalog entries organizing the asset metadata in the impactful corpus catalog. Each catalog entry, in the catalog entry subset, may include asset metadata that, at least in part, matches (or is substantially similar to) one or more field input(s) in the at least one field input. Each catalog entry, in the catalog entry subset, further, may map/correspond to an (impactful) asset that at least discusses one or more field input(s) in the at least one field input.

In one or many embodiment(s) disclosed herein, the impactful corpus catalog (obtained in Step 316) may be further filtered using or based on the at least one filtering assessment parameter (identified in Step 324). More specifically, when filtering the impactful corpus catalog, only certain metadata field(s) of the asset metadata, maintained across the set of catalog entries, may be considered. Further, each metadata field, in said certain metadata field(s), may match a filtering assessment parameter in the at least one filtering assessment parameter.

In Step 328, following the alternative determination (made in Step 320)) that the search (performed in Step 318) failed in identifying at least one non-empty form field, or following the identification of a catalog entry subset (in Step 326), an asset metadata subset is identified. In one or many embodiment(s) disclosed herein, the asset metadata subset may encompass a certain metadata field of the collective asset metadata that spans across either the set of catalog entries (obtained via the impactful corpus catalog in Step 316) or the catalog entry subset (in said set of catalog entries identified in Step 326). Further, said certain metadata field may match the guiding assessment parameter (identified in Step 314).

In Step 330, the asset metadata subset (identified in Step 328) is analyzed. In one or many embodiment(s) disclosed herein, analysis of the asset metadata subset may result in the obtaining of guidance information. Said guidance information may include one or more recommendations for enhancing an impact factor of an unbegun research being currently evaluated using the interactive assessment form (presented to the organization user in Step 306), where the recommendation(s) center on the guiding assessment parameter (identified in Step 314).

In Step 332, the guidance information (obtained in Step 330) is subsequently presented/provided to the organization user. In one or many embodiment(s) disclosed herein, the guidance information, more specifically, may be presented by way of the interactive assessment form (presented in Step 306). Further, concerning the presentation thereof, the guidance information may be revealed, for example, as a comment, an annotation, or a dialog box. For an example revelation of guidance information, through an example interactive assessment form, refer to the example scenario illustrated and discussed with respect to FIG. 5A-5C, below.

From Step 332, the method proceeds to Step 308 (see e.g., FIG. 3A), where further engagement, by the organization user and with the interactive assessment form, is monitored.

Turning to FIG. 3C, in Step 334, following the alternative determination (made in Step 312) that any engagement action, based on the interactive assessment form engagement/interaction (monitored in Step 308), does not hovers (using a cursor) over any given form field, a determination is made as to whether said any engagement action reflects an editing of any given simple form field (described above—see e.g., Step 304). As such, in one or many embodiment(s) disclosed herein, if it is determined that any engagement action edits any given simple form field, then the method proceeds to Step 336. On the other hand, in one or many other embodiment(s) disclosed herein, if it is alternatively determined that any engagement action does not edit any given simple form field, then the method alternatively proceeds to Step 352 (see e.g., FIG. 3D).

In Step 336, following the determination (made in Step 334) that any engagement action, based on the interactive assessment form engagement/interaction (monitored in Step 308), edits any given simple form field, an assessment parameter is identified. In one or many embodiment(s) disclosed herein, said assessment parameter may represent one of the assessment parameter(s), in the set of assessment parameters (obtained in Step 302), to which the given simple form field maps/corresponds.

In Step 338, a field input, for the given simple form field, is extracted therefrom. In one or many embodiment(s) disclosed herein, the field input may refer to the (editable) text found within the given simple form field, which the organization user, via said any engagement action reflecting an editing of said given simple form field, had entered/inputted and/or edited there-within.

In Step 340, an impactful corpus catalog is obtained. In one or many embodiment(s) disclosed herein, the impactful corpus catalog may represent a data structure that maintains asset metadata describing, and thus pertaining to, a collection of impactful assets forming an impactful corpus. Each (impactful) asset in the impactful corpus may refer to any research-centered and predominantly text-based item of information (e.g., a research paper, a research thesis, a research proposal, etc.) that, over time, has, for example, positively impacted, influenced, or steered: other (future) research work in a same research space, or in one or more adjacent research spaces, as that associated with the asset; one or more advances in technology; and/or an overall direction of one or more industries. Furthermore, the asset metadata, maintained in the impactful corpus catalog, may be organized across a set of (impactful corpus) catalog entries. Each (impactful corpus) catalog entry, in the set of (impactful corpus) catalog entries, may pertain to an (impactful) asset in the impactful corpus and, therefore, may store asset metadata particular to said (impactful) asset. Further, any asset metadata may be divided into a set of metadata fields, where each metadata field further organizes the asset metadata based on a given context. Examples of asset metadata, or more specifically, metadata fields thereof, are disclosed with respect to Step 316 (see e.g., FIG. 3B), above.

In Step 342, the impactful corpus catalog (obtained in Step 340) is filtered at least based on the field input (extracted in Step 338). In one or many embodiment(s) disclosed herein, filtering of the impactful corpus catalog may, for example, entail topic matching (e.g., case-insensitive word or phrase matching) and/or semantic similarity calculation between the field input and the asset metadata, for (impactful) assets, maintained across the (impactful corpus) catalog entries of the impactful corpus catalog. Further, said filtering may result in the identification of a catalog entry subset in (or a subset of) the set of catalog entries organizing the asset metadata in the impactful corpus catalog. Each catalog entry, in the catalog entry subset, may include asset metadata that, at least in part, matches (or is substantially similar to) the input field. Each catalog entry, in the catalog entry subset, further, may map/correspond to an (impactful) asset that at least discusses the input field.

In one or many embodiment(s) disclosed herein, the impactful corpus catalog (obtained in Step 340) may be further filtered using or based on the assessment parameter (identified in Step 336). More specifically, when filtering the impactful corpus catalog, only a certain metadata field of the asset metadata, maintained across the set of (impactful corpus) catalog entries, may be considered. Further, the certain metadata field may match the assessment parameter.

In Step 344, an overall corpus catalog is obtained. In one or many embodiment(s) disclosed herein, the overall corpus catalog may represent a data structure that maintains asset metadata describing, and thus pertaining to, a collection of assets forming an overall corpus, where the overall corpus represents a superset of assets that includes the asset(s) forming the impactful corpus. Each asset in the overall corpus, accordingly, may refer to any research-centered and predominantly text-based item of information (e.g., a research paper, a research thesis, a research proposal, etc.), which may or may not be representative of an impactful asset. Furthermore, the asset metadata, maintained in the overall corpus catalog, may be organized across a set of (overall corpus) catalog entries. Each (overall corpus) catalog entry, in the set of (overall corpus) catalog entries, may pertain to an asset in the overall corpus and, therefore, may store asset metadata particular to said asset. Further, any asset metadata may be divided into a set of metadata fields, where each metadata field further organizes the asset metadata based on a given context. Examples of asset metadata, or more specifically, metadata fields thereof, are disclosed with respect to Step 316 (see e.g., FIG. 3B), above.

In Step 346, a parameter-specific impact score is computed. In one or many embodiment(s) disclosed herein, the parameter-specific impact score may refer to an item of information (e.g., usually expressed as a positive numerical value or a percentage value) that conveys a partial impact factor of an unbegun research being currently evaluated using the interactive assessment form (presented to the organization user in Step 306). The partial impact factor, in turn, may measure a prospective usefulness and/or success of the unbegun research as said prospective usefulness and/or success pertains to (or considers) a particular assessment parameter (e.g., the assessment parameter (identified in Step 336)). Further, computation of the parameter-specific impact score may rely on a cardinality of the (impactful corpus) catalog entry subset (identified in Step 342) (i.e., a number of catalog entries forming the (impactful corpus) catalog entry subset) and a cardinality of the set of catalog entries forming the overall corpus catalog (obtained in Step 344) (i.e., a number of catalog entries forming the overall corpus catalog).

By way of an example, the parameter-specific impact score may be calculated via a simple mathematical division function, where the numerator (or dividend) of said division is represented by the number of catalog entries forming the (impactful corpus) catalog entry subset, while the denominator (or divisor) of said division is represented by the number of catalog entries forming the overall corpus catalog. Accordingly, in such an example, the parameter-specific impact score may represent the quotient resulting from said division, which may be expressed as a positive decimal value or a percentage value. Further, computation of the parameter-specific impact score, based on the number of (impactful corpus) catalog subset entries and the number of (overall corpus) catalog entries, is not limited to the aforementioned specific example.

In Step 348, an overall impact score is computed. In one or many embodiment(s) disclosed herein, the overall impact score may refer to an item of information (e.g., usually expressed as a positive numerical value or a percentage value) that conveys a total impact factor of an unbegun research being currently evaluated using the interactive assessment form (presented to the organization user in Step 306). The total impact factor, in turn, may measure a prospective usefulness and/or success of the unbegun research as said prospective usefulness and/or success pertains to (or considers) all assessment parameters in the set of assessment parameters (obtained in Step 302). Further, each assessment parameter, in the set of assessment parameters, may be associated with a respective parameter-specific impact score in a set of parameter-specific impact scores (including the parameter-specific impact score (computed in Step 346)). Accordingly, computation of the overall impact score may rely on the set of parameter-specific impact scores.

For example, the overall impact score may be calculated using a weighted mathematical function involving each parameter-specific impact score (e.g., whether the parameter-specific impact score reflects a zero or non-zero numerical or percentage value) in the set of parameter-specific impact scores. In such an example, the overall impact score may represent the result of said weighted mathematical function, which may be expressed as a positive numerical value or a percentage value. Further, computation of the overall impact score, based on the set of parameter-specific impact scores, is not limited to the aforementioned specific example.

In Step 350, the interactive assessment form (presented in Step 306) is updated. Specifically, in one or many embodiment(s) disclosed herein, of the collection of interactive form components composing the interactive assessment form: one parameter-specific impact score indicator, in the set of parameter-specific impact score indicators, may be updated using the parameter-specific impact score (computed in Step 346); and an/the overall impact score indicator may be updated using the overall impact score (computed in Step 348). More specifically, a previous parameter-specific impact score, displayed by the one parameter-specific impact score indicator, may be replaced with the recently computed parameter-specific impact score; whereas a previous overall impact score, displayed by the overall score indicator, may be replaced with the recently computed overall impact score. Further, the one parameter-specific impact score indicator may map or correspond to the assessment parameter (identified in Step 336).

From Step 350, the method proceeds to Step 308 (see e.g., FIG. 3A), where further engagement, by the organization user and with the interactive assessment form, is monitored.

Turning to FIG. 3D, in Step 352, following the determination (made in Step 334) that any engagement action, based on the interactive assessment form engagement/interaction (monitored in Step 308), does not edit any given simple form field, a determination is made as to whether said any engagement action reflects an editing of any given complex form field (described above—see e.g., Step 304). As such, in one or many embodiment(s) disclosed herein, if it is determined that any engagement action edits any given complex form field, then the method proceeds to Step 354. On the other hand, in one or many other embodiment(s) disclosed herein, if it is alternatively determined that any engagement action does not edit any given complex form field, then the method alternatively proceeds to Step 374 (see e.g., FIG. 3E).

In Step 354, following the determination (made in Step 352) that any engagement action, based on the interactive assessment form engagement/interaction (monitored in Step 308), edits any given complex form field, an assessment parameter is identified. In one or many embodiment(s) disclosed herein, said assessment parameter may represent one of the assessment parameter(s), in the set of assessment parameters (obtained in Step 302), to which the given complex form field maps/corresponds.

In Step 356, a field input, for the given complex form field, is extracted therefrom. In one or many embodiment(s) disclosed herein, the field input may refer to the (editable) text found within the given complex form field, which the organization user, via said any engagement action reflecting an editing of said given complex form field, had entered/inputted and/or edited there-within.

In Step 358, an impactful corpus catalog is obtained. In one or many embodiment(s) disclosed herein, the impactful corpus catalog may represent a data structure that maintains asset metadata describing, and thus pertaining to, a collection of impactful assets forming an impactful corpus. Each (impactful) asset in the impactful corpus may refer to any research-centered and predominantly text-based item of information (e.g., a research paper, a research thesis, a research proposal, etc.) that, over time, has, for example, positively impacted, influenced, or steered: other (future) research work in a same research space, or in one or more adjacent research spaces, as that associated with the asset; one or more advances in technology; and/or an overall direction of one or more industries. Furthermore, the asset metadata, maintained in the impactful corpus catalog, may be organized across a set of (impactful corpus) catalog entries. Each (impactful corpus) catalog entry, in the set of (impactful corpus) catalog entries, may pertain to an (impactful) asset in the impactful corpus and, therefore, may store asset metadata particular to said (impactful) asset. Further, any asset metadata may be divided into a set of metadata fields, where each metadata field further organizes the asset metadata based on a given context. Examples of asset metadata, or more specifically, metadata fields thereof, are disclosed with respect to Step 316 (see e.g., FIG. 3B), above.

In Step 360, the impactful corpus catalog (obtained in Step 358) is filtered at least based on the field input (extracted in Step 356). In one or many embodiment(s) disclosed herein, filtering of the impactful corpus catalog may, for example, entail topic matching (e.g., case-insensitive word or phrase matching) and/or semantic similarity calculation between the field input and the asset metadata, for (impactful) assets, maintained across the (impactful corpus) catalog entries of the impactful corpus catalog. Further, said filtering may result in the identification of a catalog entry subset in (or a subset of) the set of catalog entries organizing the asset metadata in the impactful corpus catalog. Each catalog entry, in the catalog entry subset, may include asset metadata that, at least in part, matches (or is substantially similar to) the input field. Each catalog entry, in the catalog entry subset, further, may map/correspond to an (impactful) asset that at least discusses the input field.

In one or many embodiment(s) disclosed herein, the impactful corpus catalog (obtained in Step 358) may be further filtered using or based on the assessment parameter (identified in Step 354). More specifically, when filtering the impactful corpus catalog, only a certain metadata field of the asset metadata, maintained across the set of (impactful corpus) catalog entries, may be considered. Further, the certain metadata field may match the assessment parameter.

In Step 362, an overall corpus catalog is obtained. In one or many embodiment(s) disclosed herein, the overall corpus catalog may represent a data structure that maintains asset metadata describing, and thus pertaining to, a collection of assets forming an overall corpus, where the overall corpus represents a superset of assets that includes the asset(s) forming the impactful corpus. Each asset in the overall corpus, accordingly, may refer to any research-centered and predominantly text-based item of information (e.g., a research paper, a research thesis, a research proposal, etc.), which may or may not be representative of an impactful asset. Furthermore, the asset metadata, maintained in the overall corpus catalog, may be organized across a set of (overall corpus) catalog entries. Each (overall corpus) catalog entry, in the set of (overall corpus) catalog entries, may pertain to an asset in the overall corpus and, therefore, may store asset metadata particular to said asset. Further, any asset metadata may be divided into a set of metadata fields, where each metadata field further organizes the asset metadata based on a given context. Examples of asset metadata, or more specifically, metadata fields thereof, are disclosed with respect to Step 316 (see e.g., FIG. 3B), above.

In Step 364, a parameter-specific impact score is computed. In one or many embodiment(s) disclosed herein, the parameter-specific impact score may refer to an item of information (e.g., usually expressed as a positive numerical value or a percentage value) that conveys a partial impact factor of an unbegun research being currently evaluated using the interactive assessment form (presented to the organization user in Step 306). The partial impact factor, in turn, may measure a prospective usefulness and/or success of the unbegun research as said prospective usefulness and/or success pertains to (or considers) a particular assessment parameter (e.g., the assessment parameter (identified in Step 354)). Further, computation of the parameter-specific impact score may rely on a cardinality of the (impactful corpus) catalog entry subset (identified in Step 360) (i.e., a number of catalog entries forming the (impactful corpus) catalog entry subset) and a cardinality of the set of catalog entries forming the overall corpus catalog (obtained in Step 362) (i.e., a number of catalog entries forming the overall corpus catalog).

By way of an example, the parameter-specific impact score may be calculated via a simple mathematical division function, where the numerator (or dividend) of said division is represented by the number of catalog entries forming the (impactful corpus) catalog entry subset, while the denominator (or divisor) of said division is represented by the number of catalog entries forming the overall corpus catalog. Accordingly, in such an example, the parameter-specific impact score may represent the quotient resulting from said division, which may be expressed as a positive decimal value or a percentage value. Further, computation of the parameter-specific impact score, based on the number of (impactful corpus) catalog subset entries and the number of (overall corpus) catalog entries, is not limited to the aforementioned specific example.

In Step 366, an overall impact score is computed. In one or many embodiment(s) disclosed herein, the overall impact score may refer to an item of information (e.g., usually expressed as a positive numerical value or a percentage value) that conveys a total impact factor of an unbegun research being currently evaluated using the interactive assessment form (presented to the organization user in Step 306). The total impact factor, in turn, may measure a prospective usefulness and/or success of the unbegun research as said prospective usefulness and/or success pertains to (or considers) all assessment parameters in the set of assessment parameters (obtained in Step 302). Further, each assessment parameter, in the set of assessment parameters, may be associated with a respective parameter-specific impact score in a set of parameter-specific impact scores (including the parameter-specific impact score (computed in Step 364)). Accordingly, computation of the overall impact score may rely on the set of parameter-specific impact scores.

For example, the overall impact score may be calculated using a weighted mathematical function involving each parameter-specific impact score (e.g., whether the parameter-specific impact score reflects a zero or non-zero numerical or percentage value) in the set of parameter-specific impact scores. In such an example, the overall impact score may represent the result of said weighted mathematical function, which may be expressed as a positive numerical value or a percentage value. Further, computation of the overall impact score, based on the set of parameter-specific impact scores, is not limited to the aforementioned specific example.

In Step 368, the interactive assessment form (presented in Step 306) is updated. Specifically, in one or many embodiment(s) disclosed herein, of the collection of interactive form components composing the interactive assessment form: one parameter-specific impact score indicator, in the set of parameter-specific impact score indicators, may be updated using the parameter-specific impact score (computed in Step 364); and an/the overall impact score indicator may be updated using the overall impact score (computed in Step 366). More specifically, a previous parameter-specific impact score, displayed by the one parameter-specific impact score indicator, may be replaced with the recently computed parameter-specific impact score; whereas a previous overall impact score, displayed by the overall score indicator, may be replaced with the recently computed overall impact score. Further, the one parameter-specific impact score indicator may map or correspond to the assessment parameter (identified in Step 354).

From Step 368, the method proceeds to Step 370 (see e.g., FIG. 3E).

Turning to FIG. 3E, in Step 370, an asset metadata subset is identified and analyzed. In one or many embodiment(s) disclosed herein, the asset metadata subset may encompass a certain metadata field of the collective asset metadata that spans across the (impactful corpus) catalog entry subset (identified in Step 360). Further, said certain metadata field may match the assessment parameter (identified in Step 354). Further, analysis of the asset metadata subset may result in the obtaining of guidance information. Said guidance information may include one or more recommendations for enhancing an impact factor of an unbegun research being currently evaluated using the interactive assessment form (presented to the organization user in Step 306), where the recommendation(s) center on any impactful prose (or language) captured as asset metadata for one or more impactful assets mapped, respectively, to one or more (impactful corpus) catalog entries in the (impactful corpus) catalog entry subset (identified in Step 360).

In Step 372, the guidance information (obtained in Step 370) is subsequently presented/provided to the organization user. In one or many embodiment(s) disclosed herein, the guidance information, more specifically, may be presented by way of the interactive assessment form (presented in Step 306). Further, concerning the presentation thereof, the guidance information may be revealed, for example, as a comment, an annotation, or a dialog box. For an example revelation of guidance information, through an example interactive assessment form, refer to the example scenario illustrated and discussed with respect to FIG. 5A-5C, below.

From Step 372, the method proceeds to Step 308 (see e.g., FIG. 3A), where further engagement, by the organization user and with the interactive assessment form, is monitored.

In Step 374, following the alternative determination (made in Step 352) that any engagement action, based on the interactive assessment form engagement/interaction (monitored in Step 308), does not edit any given complex form field, a determination is made as to whether said any engagement action reflects a hovering (using a cursor) over any given parameter-specific impact score indicator (described above—see e.g., Step 304). As such, in one or many embodiment(s) disclosed herein, if it is determined that any engagement action hovers over any given parameter-specific impact score indicator, then the method proceeds to Step 376. On the other hand, in one or many other embodiment(s) disclosed herein, if it is alternatively determined that any engagement action does not hover over any given parameter-specific impact score indicator, then the method alternatively proceeds to Step 308 (see e.g., FIG. 3A), where further engagement, by the organization user and with the interactive assessment form, is monitored.

In Step 376, following the determination (made in Step 374) that any engagement action, based on the interactive assessment form engagement/interaction (monitored in Step 308), hovers (using a cursor) over any given parameter-specific impact score indicator, an assessment parameter, and a corresponding form field, are identified. In one or many embodiment(s) disclosed herein, said assessment parameter may represent one of the assessment parameter(s), in the set of assessment parameters (obtained in Step 302), to which the given parameter-specific impact score indicator maps/corresponds. Meanwhile, said form field may represent one of the form field(s), in the set of form fields, at least in part, composing the interactive assessment form (presented in Step 306), to which the given parameter-specific impact score indicator maps/corresponds.

In Step 378, a field input, for the form field (identified in Step 376), is extracted therefrom. In one or many embodiment(s) disclosed herein, the field input may refer to the (editable) text found within the form field, which the organization user, at some prior point-in-time, had entered/inputted and/or edited there-within.

In Step 380, an impactful corpus catalog is obtained. In one or many embodiment(s) disclosed herein, the impactful corpus catalog may represent a data structure that maintains asset metadata describing, and thus pertaining to, a collection of impactful assets forming an impactful corpus. Each (impactful) asset in the impactful corpus may refer to any research-centered and predominantly text-based item of information (e.g., a research paper, a research thesis, a research proposal, etc.) that, over time, has, for example, positively impacted, influenced, or steered: other (future) research work in a same research space, or in one or more adjacent research spaces, as that associated with the asset; one or more advances in technology; and/or an overall direction of one or more industries. Furthermore, the asset metadata, maintained in the impactful corpus catalog, may be organized across a set of (impactful corpus) catalog entries. Each (impactful corpus) catalog entry, in the set of (impactful corpus) catalog entries, may pertain to an (impactful) asset in the impactful corpus and, therefore, may store asset metadata particular to said (impactful) asset. Further, any asset metadata may be divided into a set of metadata fields, where each metadata field further organizes the asset metadata based on a given context. Examples of asset metadata, or more specifically, metadata fields thereof, are disclosed with respect to Step 316 (see e.g., FIG. 3B), above.

In Step 382, the impactful corpus catalog (obtained in Step 380) is filtered at least based on the field input (extracted in Step 378). In one or many embodiment(s) disclosed herein, filtering of the impactful corpus catalog may, for example, entail topic matching (e.g., case-insensitive word or phrase matching) and/or semantic similarity calculation between the field input and the asset metadata, for (impactful) assets, maintained across the (impactful corpus) catalog entries of the impactful corpus catalog. Further, said filtering may result in the identification of a catalog entry subset in (or a subset of) the set of catalog entries organizing the asset metadata in the impactful corpus catalog. Each catalog entry, in the catalog entry subset, may include asset metadata that, at least in part, matches (or is substantially similar to) the input field. Each catalog entry, in the catalog entry subset, further, may map/correspond to an (impactful) asset that at least discusses the input field.

In one or many embodiment(s) disclosed herein, the impactful corpus catalog (obtained in Step 380) may be further filtered using or based on the assessment parameter (identified in Step 376). More specifically, when filtering the impactful corpus catalog, only a certain metadata field of the asset metadata, maintained across the set of (impactful corpus) catalog entries, may be considered. Further, the certain metadata field may match the assessment parameter.

In Step 384, an overall corpus catalog is obtained. In one or many embodiment(s) disclosed herein, the overall corpus catalog may represent a data structure that maintains asset metadata describing, and thus pertaining to, a collection of assets forming an overall corpus, where the overall corpus represents a superset of assets that includes the asset(s) forming the impactful corpus. Each asset in the overall corpus, accordingly, may refer to any research-centered and predominantly text-based item of information (e.g., a research paper, a research thesis, a research proposal, etc.), which may or may not be representative of an impactful asset. Furthermore, the asset metadata, maintained in the overall corpus catalog, may be organized across a set of (overall corpus) catalog entries. Each (overall corpus) catalog entry, in the set of (overall corpus) catalog entries, may pertain to an asset in the overall corpus and, therefore, may store asset metadata particular to said asset. Further, any asset metadata may be divided into a set of metadata fields, where each metadata field further organizes the asset metadata based on a given context. Examples of asset metadata, or more specifically, metadata fields thereof, are disclosed with respect to Step 316 (see e.g., FIG. 3B), above.

From Step 384, the method proceeds to Step 386 (see e.g., FIG. 3F).

Turning to FIG. 3F, in Step 386, cardinalities for the (impactful corpus) catalog entry subset (identified in Step 382) and the set of (overall corpus) catalog entries, the latter respective to the overall corpus catalog (obtained in Step 384), are obtained. In one or many embodiment(s) disclosed herein, a cardinality of the (impactful corpus) catalog entry subset may reference a number of catalog entries forming the (impactful corpus) catalog entry subset. Meanwhile, a cardinality of the set of catalog entries respective to (or forming) the overall corpus catalog may reference a number of catalog entries forming the overall corpus catalog.

In Step 388, an impactful-to-overall asset ratio is derived. In one or many embodiment(s) disclosed herein, a ratio may generally reference a relationship between two objects, or a relationship a first object of the two objects has with respect to a second object of the two objects. To that end, the impactful-to-overall asset ratio, which may be derived using the cardinalities (obtained in Step 386) for the (impactful corpus) catalog entry set (identified in Step 382) and the set of (overall corpus) catalog entries forming the overall corpus catalog (obtained in Step 384), may reflect a relationship between the two said cardinalities.

In Step 390, the impactful-to-overall asset ratio (derived in Step 388) is presented to the organization user. In one or many embodiment(s) disclosed herein, the impactful-to-overall asset ratio, more specifically, may be presented by way of the interactive assessment form (presented in Step 306). Further, concerning the presentation thereof, the impactful-to-overall asset ratio may be revealed, for example, as a comment, an annotation, or a dialog box. For an example revelation of the impactful-to-overall asset ratio, through an example interactive assessment form, refer to the example scenario illustrated and discussed with respect to FIG. 5A-5C, below.

From Step 390, the method proceeds to Step 308 (see e.g., FIG. 3A), where further engagement, by the organization user and with the interactive assessment form, is monitored.

FIG. 4 shows an example computing system in accordance with one or more embodiments disclosed herein. The computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment disclosed herein, the computer processor(s) (402) may be an integrated circuit for processing instructions. For example, the computer processor(s) may be one or more cores or micro-cores of a central processing unit (CPU) and/or a graphics processing unit (GPU). The computing system (400) may also include one or more input devices (410), such as a touchscreen, keyboard, mouse, microphone, touchpad, electronic pen, or any other type of input device. Further, the communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

In one embodiment disclosed herein, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments disclosed herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments disclosed herein.

FIG. 5A-5C show an example scenario in accordance with one or more embodiments disclosed herein. The example scenario, illustrated through FIG. 5A-5C and described below, is for explanatory purposes only and not intended to limit the scope disclosed herein.

Hereinafter, consider the following example scenario whereby an organization user, identified as Scott, seeks to draft/write a research paper centered on data marketplaces. Scott, however, is uncertain whether the topic is worth the time and effort to pursue. To that end, Scott initiates an impact assessment program on his laptop computer (e.g., client device), where the impact assessment program is configured to evaluate said unbegun research (to be conveyed through a research paper medium) and provide recommendations for enhancing an impact factor thereof. Initiation of the impact assessment program is detected by the Insight Service via an Insight Agent executing on the laptop computer and embedded within (or otherwise associated with) the impact assessment program. Further, following said initiation, a set of assessment parameters (e.g., author name(s), affiliation(s), topic, keyword(s), abstract, and body) is/are obtained and, based on the set of assessment parameters, an interactive assessment form (see e.g., FIG. 5A) is instantiated and subsequently presented to Scott via a user interface (UI) of the impact assessment program.

Turning to FIG. 5A, an example impact assessment program UI (500) is depicted, where an example interactive assessment form (502), moreover, is instantiated there-within. The example interactive assessment form (502) is composed of various interactive form components, including: (a) a set of form fields (504) each representing an editable text field wherein text, respective to a corresponding assessment parameter, can be entered and edited; (b) a set of form field labels (506) each representing a static text field serving as an associated tag to a respective form field so that Scott would know what information to enter where; (c) a set of parameter-specific impact score indicators (508) each representing a response-driven text field displaying a current parameter-specific impact score respective to a corresponding assessment parameter; and (d) an overall impact score indicator (510) representing a response-driven text field displaying a current overall impact score for the unbegun research (e.g., a yet to be drafted research paper centered on data marketplaces) currently being evaluated.

Following presentation of the interactive assessment form, and based on certain subsequent interactions (or engagement actions) by Scott and applied to the interactive assessment form (or the various interactive form components thereof), the Insight Service proceeds to follow embodiments disclosed herein pertaining to impact enhancing recommendations for research papers and initiatives as applied to the circumstances of the example scenario.

Turning to FIG. 5B, Scott, thereafter, identifies a form field (504A), corresponding to a topic assessment parameter, based on an associated form field label (506A). Then, within the identified form field (504A), Scott enters (e.g., types in) the text “Data Marketplaces” (e.g., a field input). The Insight Service, via the Insight Agent, determines that the aforementioned engagement action, by Scott, reflects an editing of any simple form field. Based on said determination, the Insight Service identifies the topic assessment parameter, from the set of assessment parameters, as corresponding to the form field (504A) and, subsequently, extracts the field input therefrom.

Next, the Insight Service obtains an impactful corpus catalog, maintained thereby, which includes a set of impactful corpus catalog entries each storing asset metadata (divided into various metadata fields) describing a respective impactful asset. The impactful corpus catalog is then filtered based on the topic assessment parameter and the field input, which leads to the identification of two (2) impactful corpus catalog entries representing an impactful corpus catalog entry subset.

The Insight Service, afterwards, obtains an overall corpus catalog, also maintained thereby, which includes a set of overall corpus catalog entries each storing asset metadata (divided into various metadata fields) describing a respective asset, where the asset is either an impactful asset or a non-impactful asset. A parameter-specific impact score, corresponding to the topic assessment parameter, is computed based on a number of impactful catalog entries (e.g., two) in the impactful corpus catalog entry subset and a number of overall corpus catalog entries (e.g., two-hundred) in the set of overall corpus catalog entries. A simple division function (at least for the purposes of the example scenario) is used to compute the parameter-specific impact score. Thus, the parameter-specific impact score=2/200=0.01 (or 1%). Subsequently, the Insight Service computes an overall impact score based on a (current) set of parameter-specific impact scores, which includes the recently computed parameter-specific impact score corresponding to the topic assessment parameter.

Returning to FIG. 5B, the example interactive assessment form (502) shows the current parameter-specific impact score (e.g., 0%) for each of the remaining assessment parameters (e.g., author name(s), affiliation(s), keyword(s), abstract, and body). Using a simple weighted summation function (at least for the purposes of the example scenario), where the weight assigned to the topic assessment parameter is 0.4, the Insight Service computes the overall impact score to be 0.4×0.01=0.004 (or <1%).

The interactive assessment form is then updated using the recently computed parameter-specific impact score (e.g., 1%), corresponding to the topic assessment parameter, and the recently computed overall impact score (e.g., <1%). More specifically, as conveyed through the example interactive assessment form (502) in FIG. 5B, the previous parameter-specific impact score (e.g., 0%), which had been displayed by a parameter-specific impact score indicator (508A) respective to the topic assessment parameter, is replaced with the recently computed parameter-specific impact score (e.g., 1%). Further, a previous overall impact score (e.g., 0%), which had been displayed by the overall impact score indicator (510), is replaced with the recently computed overall impact score (e.g., <1%).

Based on the topic (e.g., Data Marketplaces) for his unbegun research (e.g., a yet to be drafted research paper centered on data marketplaces) alone, and through the recently computed parameter-specific impact score (e.g., 1%) and the recently computed overall impact score (e.g., <1%), Scott can ascertain that an impact factor associated with his unbegun research is looking dismal. Not ready to give up on the matter, Scott interacts with the interactive assessment form some more in an attempt to receive guidance that could enhance the impacted factor associated with his unbegun research.

Turning to FIG. 5C, Scott, thereafter, identifies another form field (504B), corresponding to an affiliation(s) assessment parameter, based on an associated form field label (506B). Then, using the cursor (512), Scott hovers over the identified form field (504B). The Insight Service, via the Insight Agent, determines that the aforementioned engagement action, by Scott, reflects a hovering over of any form field. Based on said determination, the Insight Service identifies the affiliation(s) assessment parameter (representing a guiding assessment parameter), from the set of assessment parameters, as corresponding to the form field (504B).

Next, the Insight Service (re-)obtains the impactful corpus catalog, maintained thereby, which includes a set of impactful corpus catalog entries each storing asset metadata (divided into various metadata fields) describing a respective impactful asset. Afterwards, a search is conducted in an attempt to identify any non-empty form field(s). The search results in the identification of the first form field (504A), which includes the text “Data Marketplaces” (e.g., a field input) there-within and is thus determined to be a non-empty form field. The field input, within the identified first form field (504A), is extracted therefrom and the topic assessment parameter (representing a filtering assessment parameter), from the set of assessment parameters, is identified as corresponding to the identified first form field (504A).

The Insight Service then filters the (re-)obtained impactful corpus catalog based on the filtering assessment parameter and the field input, which again leads to the identification of two (2) impactful corpus catalog entries representing an impactful corpus catalog entry subset. Subsequently, a metadata field, of the various metadata fields dividing the asset metadata stored across the impactful corpus catalog entry subset, is identified, where the metadata field matches the guiding assessment parameter. From here, an asset metadata subset, including the collective asset metadata respective to the identified metadata field and from the two (2) impactful corpus catalog entries representing the impactful corpus catalog entry subset, is obtained.

Thereafter, the Insight Service analyzes the obtained asset metadata subset, thereby resulting in the obtaining of guidance information. The guidance information suggests partnering with Data Marketplace authors affiliated with Stanford University and the Massachusetts Institute of Technology (MIT) in order to enhance the impact factor for the unbegun research (e.g., a yet to be drafted research paper centered on data marketplaces) currently being evaluated. The guidance information, further, includes links pointing to maintained metadata describing the suggested Data Marketplace authors. The guidance information, further, is presented to Scott through the interactive assessment form.

Returning to FIG. 5C, the guidance information (3114) (at least for the purposes of the example scenario) is shown as a comment pointing at another parameter-specific impact score indicator (508B), from the set of parameter-specific impact score indicators, which corresponds to the guiding assessment parameter (e.g., the affiliation(s) assessment parameter) and, by association, to the second form field (504B) being hovered over using the cursor (512). Further, within the shown comment, the above-mentioned links, pointing to maintained metadata describing the suggested Data Marketplace authors, are conveyed through the underlined terms “Stanford” and “MIT” therein.

From here, Scott may or may not opt to follow the guidance information provided by the Insight Service. Should Scott choose to follow the guidance information, he may click on the links, embedded in the guidance information, to discover the metadata describing the suggested Data Marketplace authors. Further, Scott may then enter the author names, for the suggested Data Marketplace authors and from the metadata, into the second form field (504B) respective to the affiliation(s) assessment parameter. In doing so, Scott may observe the second parameter-specific impact score indicator (508B) displaying a new, non-zero parameter-specific impact score corresponding to the affiliation(s) assessment parameter, as well as the overall impact score indicator (510) displaying a new, increased overall impact score, where both said scores would be re-computed in response to Scott's interaction with (e.g., the entering of text into) the second form field (504B).

While the embodiments disclosed herein have been described with respect to a limited number of embodiments, those skilled in the art, having benefit of this disclosure, will appreciate that other embodiments can be devised which do not depart from the scope disclosed herein as disclosed herein. Accordingly, the scope disclosed herein should be limited only by the attached claims.

What is claimed is:

1. A method for providing guidance, the method comprising:
detecting an initiation, by an organization user, of an impact assessment program;
instantiating an interactive assessment form comprising a set of form fields;
presenting, through the impact assessment program, the interactive assessment form to the organization user;
monitoring interactions, by the organization user, with the interactive assessment form to identify an engagement action;
analyzing, based on the engagement action and to obtain guidance information, an impactful corpus catalog comprising a set of catalog entries; and
providing, through the interactive assessment form, the guidance information to the organization user.

2. The method of claim 1, wherein the guidance information comprises at least one recommendation directed to enhancing an impact of one selected from a group comprising a research paper that has yet to be drafted, and a research initiative that has yet to be pursued, by the organization user.

3. The method of claim 1, wherein the engagement action reflects a hovering over of a form field in the set of form fields.

4. The method of claim 3, wherein analyzing, based on the engagement action, the impactful corpus catalog to obtain the guidance information, comprises:
making a determination, based on a search across the set of form fields, that at least one form field, in the set of form fields, is a non-empty form field;
extracting, based on the determination and from the at least one form field, a field input to obtain at least one field input;
filtering, based on the at least one field input, the impactful corpus catalog to identify a catalog entry subset in the set of catalog entries; and
analyzing asset metadata, maintained across the catalog entry subset, to obtain the guidance information.

5. The method of claim 4, wherein the form field is one selected from a group comprising included in, and excluded from, the at least one form field.

6. The method of claim 4, wherein analyzing, based on the engagement action, the impactful corpus catalog to obtain the guidance information, further comprises:
prior to filtering the impactful corpus catalog:
mapping the at least one form field, respectively, to at least one filtering assessment parameter in a set of assessment parameters,
wherein the impactful corpus catalog is filtered further based on the at least one filtering assessment parameter.

7. The method of claim 4, wherein analyzing, based on the engagement action, the impactful corpus catalog to obtain the guidance information, further comprises:
prior to making the determination:
mapping the form field to a guiding assessment parameter in a set of assessment parameters,
wherein the asset metadata belongs to a metadata field matching the guiding assessment parameter.

8. The method of claim 4, wherein monitoring the interactions, by the organization user, with the interactive assessment form further identifies a second engagement action.

9. The method of claim 8, wherein the second engagement action reflects an editing of a second form field in the set of form fields.

10. The method of claim 9, the method further comprising:
for one selected from a group comprising prior to, and after, providing the guidance information:
identifying an assessment parameter mapped to the second form field;
extracting a second field input from the second form field;
filtering, based on the assessment parameter and the second field input, the impactful corpus catalog to identify a second catalog entry subset in the set of catalog entries;
obtaining an overall corpus catalog comprising a second set of catalog entries;
computing a parameter-specific impact score based on a first cardinality of the second catalog entry subset and a second cardinality of the second set of catalog entries;
computing an overall impact score based on a set of parameter-specific impact scores comprising the parameter-specific impact score; and
updating the interactive assessment form using the parameter-specific impact score and the overall impact score.

11. The method of claim 10, wherein the interactive assessment form further comprises a set of parameter-specific impact score indicators, and wherein updating the interactive assessment form comprises:
identifying a parameter-specific impact score indicator, in the set of parameter-specific impact score indicators, mapped to the assessment parameter; and
replacing, with the parameter-specific impact score, a previous parameter-specific impact score displayed by the parameter-specific impact score indicator.

12. The method of claim 11, wherein the interactive assessment form further comprises an overall impact score indicator, and wherein updating the interactive assessment form further comprises:
replacing, with the overall impact score, a previous impact score displayed by the overall impact score indicator.

13. The method of claim 10, wherein the second form field is a complex form field, and the method further comprises:
after updating the interactive assessment form:
identifying, from metadata collectively maintained across the second catalog entry subset, a metadata subset associated with a metadata field matching the assessment parameter;
analyzing the metadata subset to obtain second guidance information; and
providing, through the interactive assessment form, the second guidance information to the organization user.

14. The method of claim 9, wherein the second form field is one selected from a group comprising a same form field, and a different form field, as the form field.

15. The method of claim 3, wherein analyzing, based on the engagement action, the impactful corpus catalog to obtain the guidance information, comprises:
mapping the form field to a guiding assessment parameter in a set of assessment parameters;
making a determination, based on a search across the set of form fields, that each form field, in the set of form fields, is an empty form field; and
analyzing, based on the determination, asset metadata across the set of catalog entries to obtain the guidance information,
wherein the asset metadata belongs to a metadata field matching the guiding assessment parameter.

16. A non-transitory computer readable medium (CRM) comprising computer readable program code, which when executed by a computer processor, enables the computer processor to perform a method for providing guidance, the method comprising:
detecting an initiation, by an organization user, of an impact assessment program;
instantiating an interactive assessment form comprising a set of form fields;
presenting, through the impact assessment program, the interactive assessment form to the organization user;
monitoring interactions, by the organization user, with the interactive assessment form to identify an engagement action;
analyzing, based on the engagement action and to obtain guidance information, an impactful corpus catalog comprising a set of catalog entries; and
providing, through the interactive assessment form, the guidance information to the organization user.

17. The non-transitory CRM of claim 16, wherein the guidance information comprises at least one recommendation directed to enhancing an impact of one selected from a group comprising a research paper that has yet to be drafted, and a research initiative that has yet to be pursued, by the organization user.

18. The non-transitory CRM of claim 16, wherein the engagement action reflects a hovering over of a form field in the set of form fields.

19. The non-transitory CRM of claim 18, wherein analyzing, based on the engagement action, the impactful corpus catalog to obtain the guidance information, comprises:
making a determination, based on a search across the set of form fields, that at least one form field, in the set of form fields, is a non-empty form field;
extracting, based on the determination and from the at least one form field, a field input to obtain at least one field input;
filtering, based on the at least one field input, the impactful corpus catalog to identify a catalog entry subset in the set of catalog entries; and
analyzing asset metadata, maintained across the catalog entry subset, to obtain the guidance information.

20. A system, the system comprising:
a client device; and
an insight service operatively connected to the client device, and comprising a computer processor configured to perform a method for providing guidance, the method comprising:
detecting an initiation, by an organization user operating the client device, of an impact assessment program executing on the client device;
instantiating an interactive assessment form comprising a set of form fields;
presenting, through the impact assessment program, the interactive assessment form to the organization user;
monitoring interactions, by the organization user, with the interactive assessment form to identify an engagement action;
analyzing, based on the engagement action and to obtain guidance information, an impactful corpus catalog comprising a set of catalog entries; and
providing, through the interactive assessment form, the guidance information to the organization user.
